(19) United States
(12) Patent Application Publication
(10) Pub. No.: US 2022/0268206 A1
(43) Pub. Date: Aug. 25, 2022

(54) Shaft-less twin rotor turbomachinery and the applications

(71) Applicant: Jianchao shu, Cypress, TX (US)

(72) Inventor: Jianchao shu, Cypress, TX (US)

(21) Appl. No.: 17/183,279

(22) Filed: Feb. 23, 2021

(51) Int. Cl. F02C 6/02; F01D 15/08

(52) U.S. Cl. CPC F02C 6/02; F01D 15/08

(57) ABSTRACT

This invention relates to shaft-less twin rotor turbomachinery and the applications the shaft-less turbomachine has a twin tubing rotator assembly with vortical effect passages forming a high power zone and lower power zone, the twin tubing rotator assembly has two rotors to rotate independently or together with multiple powers universal bearings, high speed seal assemblies, it combines the best features of high flow rate of axial turbomachine and high pressure output of centrifugal turbomachine with the most efficient blade and turbine designs, it represents a new era of this turbomachine, disrupt invention and would power millions of turbomachines like the turbo pumps for rocket engines, jet engine/ramjet, submarines/torpedo and ships with the most advanced propellers as well as compression/pumping stations, turbines for power plants at an unprecedented level of efficiency and reliability with the twin tubing full port rotor assembly.

### CROSS-REFERENCE TO RELATED APPLICATION

This application claims the benefit of provisional patent application Ser. No. 62/982,690 filed on Feb. 27, 2020 by the present inventor.

Federally sponsored research No
Sequence listing or program No

### BACKGROUND

This invention relates to shaft-less twin rotor turbomachinery and the applications, the shaft-less turbomachine has a twin tubing rotator assembly with vortical effect passages forming a high power zone and lower power zone, the twin tubing rotator assembly has two rotors to rotate independently or together with multiple powers, universal bearings, high speed seal assemblies, it combines the best features of high flow rate of axial turbomachine and high pressure output of centrifugal turbomachine with the most efficient blade and turbine designs, it represents a new era of this turbomachine, disrupt invention and would power millions of turbomachines like the turbo pumps for rocket engines, jet engine/ramjet, submarines/torpedo and ships with the most advanced propellers as well as compression/pumping stations, turbines for power plants at an unprecedented level of efficiency and reliability with the twin tubing full port rotor assembly.

The conventional turbomachinery has been developed for more 300 years, the turbomachine accounts for 98% of power machines in the world, they are imbed in the power producing/power receiving machines like jet engine, turbo pump or the power producing machines like compressor or pump, or the power receiving machines like wind turbine, gas turbine and stream turbines as far as the efficiency is concerned, it is used as a power receiver like wind turbines, German physicist Albert Betz in 1919 concluded the efficiency limit for wind turbine is 59.3%, but in 2021 after 100 years for all practical purposes, the engineering books suggest it is about 50% or less, while the turbomachine is used as a power producer like pumps or compressors, the efficiency is about 60%, beside the efficiency issues, there are many unsolved problems (1) one common problem, they all have driven shafts which not only block the center passage to reduce flow rate about 5 to 15% in comparison with a full port passage, for example jet engine compressor, marine propeller, but also waste great deal of rotating energy, the steam turbine and gas turbines are case in a point, they count for 10 to 25% rotating energy, as we know, the larger the shaft, the more torque, but large part of the shaft center does not generate power at all but wastes materials and energy, across-the-board from turbine to pump, propeller to compressor, the conventional turbomachinery are generally divided into two groups centrifugal and axial type driving mechanisms (2) the centrifugal turbomachinery is used to power fluid and depended shaft or rotor diameter and provide high pressure but less flow rate (3) axial turbomachinery provides high flow rate at lower pressure (4) vibration, as the shaft speed up for 4000 rpm to 55000 rpm, unsupported blade edges under high velocity air stream cause uncontrolled vibrations the turbomachinery vibration reach the system limit can cause resonance, it causes so many damages and accidents (5) bearing issue for high speed turbomachinery, the bearing issue became life and dead issue for high rpm between 4000 to 55000 and up (based on FMEA), first is bearing load issues, the turbomachinery is equipped with radial ball beating even if there is side loads on the shaft, it is a main reason for vibration, other issue is overheat and wearing, since the bearing size is so small in comparison with lager diameter of rotor of turbine or compressor or pump, it is an inherent problem, the clearance becomes issue, if no clearance thermal expansion would gall the shaft and cause failure or if large clearance design with thermal expansion consideration, then at an ambient start the jet engine would vibrated violently due to large clearance, second is an over-constrain for shaft, (6) seal issue, with high speed shaft and large diameter of rotor, blade loading and overheat or low temperature, the conventional seal is no long suitable to provide seals, for the centrifugal turbo pump shaft at high speed, the centrifugal forces cause periodical seal ring disengagement, or pulse dynamic leakage, which is a root cause for most shaft leak and static seal ring leak in the flange joint, there are no good solutions so far and it may cause explosion or fire (7) overheat issue, as we hear more and more news, companies developed more heat resist materials to cope with the heat issue as well as with cooling mechanism, instead of harvesting the heat as a form of energy to power the turbomachinery (8) cavitation for liquid handling turbomachinery, it is still an issue for many marine propeller and liquid pump some solutions like front bobble injecting or super cavitation for marine propeller, but the foundational problem is the shape of blades on the propellers, too small area to handle the high pressure gradient at the edges, while centrifugal pumps also have the cavitation issue due to high pressure gradient between inlet and outlet at some small areas, no sufficient flow to fill in low pressure area, it is an inherent problem (9) shaft coupling alignments, it is an inherent problem for the turbomachine either as a power receiver or producer there is no solution, the shaft couples between steam turbine and generator or steam turbine and propeller or between electrical motors and pumps or compressors, it not only reduce efficiency, but also generate vibrations, the misalignment is major vibration source form submarines or aircraft carriers (10) noise issue, it is notoriously associated with every turbomachine from jet engines to compressors, it cause noise pollutions, and waste energy and endanger submarines.

The conventional turbo pump for rocket engine is a perfect application of the turbomachine as a power producer as well power receiver and was first developed in 1930 in German as a part of V2 rocket engine project, it combines the turbine machine ne with two centrifugal pumps, one for liquid fuel and one for liquid oxygen and by powered by a gas generator, since then, many other parts of rocket engine have been changed from fuel selection to control system, gas generator, from 4500 to 60,000, but as a heart of rocket engine, the turbo pump has not changed too much for last 70 years with old low efficiency and new problems like vibrations, overheat bearing and seals as well as durability, the durability was not an issue, because most of rocket engine is one-time use item like missile engines or few time more use like space shutters, now as more and more spacecraft companies develop reusable rocket engines, the durability, efficiency, safety for the turbo pump become more and more important, the turbo pump is the largest moving component in a rocket engine and is a main cause for vibrations beside combustions, it is relatively heavier in the engine and the middle section of turbo pump has no function to generate torque, only the edge of turbine rotor blades generates the torque, in addition the turbine injection ports are located on one side of turbine and cause lager side load on the shaft as well as vibrations, shaft leaks and ball bearings wearing out, for a rotating g machine two more radial ball bearings can cause shaft over-constraint and vibration, the shaft seal is not reliable and durable, finally turbo pump is equipped with two centrifugal pumps, the conventional centrifugal pumps produce high pressure and low flow rate, so in order to deliver the full amount of fluid volume the speed of shaft must increase up greatly, it comes with overheat, shaft leak and vibrations and energy loss on the pump diffusing area, it is vicious cycle!, the rpm was about 4500 for V2, today the rpm is 55000, and up, moreover the weight and volume of pump rotor are much higher than that of the fluids about by 65 to 35 ratio, it is a dead end.

The conventional jet engines or gas turbine are other applications; (a) poor thermal design about 20% of compressed air in the engine is used to cool the engine and not recycled. As we hear more and more news that companies developed state of the art heat resistant materials to cope with heat issues, instead of harvesting the heats as a form of energy to power the turbomachinery or jet engine, the burner is also very inefficient with multiple structures to reduce the fuel injection speed and compressed air to stabilize the combustion, the bottom line is not an innovation and does not worth it for the million spent, no company has done thoroughly thermodynamic analysis for the whole engine system (b) leak issue, there are lot of radial leaks between rotor blades and the housing the stator and the rotor blades, which accounts for 6 to 8% energy loss (c) reliability, as more and more moving parts were added to the machine like the multiple spool compressor, variable stator vane or guide vane, this effort has greatly increase difficulty of manufacturing, misalignment between the spools and as a result the vibration increases. Those efforts fundamentally violate the basic principle of reliability, the more parts, the less reliable, the more moving part, the higher failure rate (c) blades design, as far as the current jet engine blade, wind turbine blade are concerned the strength and weight has reached the limit due to shape of the blade, even with advanced materials, the nature of long, slim blade supported by a center shaft has become the bottleneck for the last few decades after million was spent (g) high system cost, the expensive rotor blade with expensive locking designs cost lot of money to produce, as well as repair, even with that, it still is the weakest link in the drive chain system, while the multiple spool compressor is other high cost item and not only costs more to produce and assemble, but also adds more moving parts, clearance control between the spools, as a result it increase more production and assembly times, about 10 to 15% cost of the engine is to spend to levitate the overheat related issues and multiple spools engagement at high speed.

The modern stream turbine was invented by Charles Parsons in 1884, there have been not too much changes since then the conventional steam turbines are constructed with a large drive shaft, a great of part material in the center section is used without generating torque, why we need to improve the efficiency? because about 85% of all electricity generation in the United States in the year 2014 was by use of steam turbines, the nuclear power plants, submarine or aircraft are powered by steam turbines, moreover the generators have the same structures and couple methods with the steam turbines have low thermal and mechanical efficiency, high vibration and unbalanced side loads and shaft coupling alignment with generator they are detrimental to submarine stealth, the some developments are in the high temperature and high pressure process but the basic structures are not much changed, the listed problems have been with us in terms of the efficiency, seal, material selections, cost and vibration and reliability for more than 100 years.

Finally the marine propellers have more than 200 year history, how many blades are needed, 3 or 4 for a propeller? is an eternal question, so far nobody has good answer, there are so many questions we cannot answer today, like how fast submarines can move without being detected, does the stealth submarine violate the conservation of energy? because any moving vehicles in water or sea need energy to separate molecules of water or seawater, unless there are 100% conversion between the moving vehicles and the water or sea water there is energy to emit into the water as form of vibration, wave or heat, if a propeller generates rotary wake under water that no other nature phenomenon or animals can generate, then submarine stealth would a great challenge, can we use a propeller without propeller wake? and what if we use up all of the engine capacity to power blades? can torpedo move in six freedoms? Even US application No. 2007/0126297 A14,667,929 to de Zwart Jun. 7, 2007) discloses a shaft less propeller powered by electric motor, except the motor driving system, there is no fluid dynamic benefits.

In conclusion, insofar no such a turbomachine is formerly developed to solve the problems or answer those questions.

### SUMMARY

This invention provides a simple, robust, reliable and versatile shaft-less twin rotor turbomachinery and its applications like hybrid turbo pump as well as for various applications even under extreme conditions, it solves the problems the conventional turbomachinery cannot solve, the hybrid turbo pump includes a twin tubing rotor assembly and a body assembly with at least one inlet and one outlet, the driving powers include gas turbine, steam turbine, electrical motor, gear train and belt motor, the twin tubing rotor assembly as a single moving part include internal blade wheel and external blade wheel and generate radial fluid movements in a high power zone as well as axial fluid movements in a center low energy zone, this unprecedented mechanism creates new solutions for the challenges the conventional turbomachinery faced, the turbomachines greatly reduce the weights and increase fluid capacity, efficiency as well as reliability.

Accordingly, besides objects and advantages of the present invention described in the above patent, several objects and advantages of the present invention are:
(a) To eliminate shaft for the turbomachines, such a machine has no an obstacle in the center passage and much less weight and increase efficiency and reliability.
(b) To provide twin rotor assembly, so the turbomachines can produce the highest efficiency with the most of mobility and reliability and balanced side load.
(c) To provide a smart rocket engine turbo pump, so the turbo pump can provide high flow rate as well high pressure to meet the requirement at lower weight, it is durable for specified number of usage and reliable with at least two redundancies, with limited speed and vibration, the driving mechanism is designed without structural side load and with balanced live load to cope with the dynamic side load and to reduce vibration and impact force, in addition, the pump is equipped with high speed seal devices for either high temperature condition or cryogenic conditions in the liquid oxygen or liquid fuel, finally the pump can be powered by multiple powers.
(d) To provide seal device with capability to sustain high rotary speed for cryogenic or high temperature services, or fire-safe applications. so such a seal device not only reduce the energy waste but also prevent explorative fluid from leaking and save life and equipment and can keep good static and dynamic seals.
(e) To provide a universal bearing, such a bearing can support radial as well as axial loads and can be sealed and self-lubricated, so the bearing can stand for high speed under cryogenic or high temperature and be easily installed and replace.
(f) To provide a smart blades structure, so the blades can sustain for high fluid load at either radial or axial or combination under high speed and reduce erosion and cavitation, it also provide high speed with low noise as well nose cancelation capability.
(g) To provide hybrid machine, so the machine can provide both gas turbine as well as stream or gas turbine with electrical power machine, so the hybrid machine can use the energy more efficiently and increase redundancy.
(h) To provide a smart propeller, such a propeller without a drive shaft can power submarines, ships, boats, torpedo as well amphibious vehicle with six freedoms.
(i) To provide a thermal efficient machine, so the machine can be powered by all energy forms, heat, pressure, kinetic movement, electrical energy, chemical energy at the highest efficiency with simple structures and materials.
(j) To provide a smart jet engine, such jet engine can be equipped with flexible power sources either for high mobile performance militate jets or high efficient commercial jet without expensive materials, complicated structures or manufacturing process.
(k) To provide versatile turbomachine, so the turbomachine can be actuated with gas turbine, steam turbine, hydraulic, solar and electrical power supply or manual or hybrid powers, such turbomachinery can be used under sea or over the sky or between land and water not only reduce the air pollution but also increase reliability and efficiency, so it can be used a pump, compressor, separator, impeller or propeller, steam turbine or gas turbine, rocket engine or jet engine.
(l) To provide a turbomachine with great scalability, the main components are with modulated designs, so most of parts are made as standard parts, a few parts are made as an adaptable parts, the inventory can be reduced, so production can be flexible as the demands decrease or increase.

Still further objects and advantages will become apparent from study of the following description and the accompanying drawings.

### DRAWINGS

Drawing Figures

FIG. 1 is an ISO view of a rocket engine with one electrical turbo pump and one gas powered turbo pump for liquid fuel and liquid oxygen constructed in accordance with this invention.

FIG. 2 is a front view of the gas powered turbo pump FIG. 1

FIG. 3 is a cross sectional view of turbo pump of FIG. 2 along line A-A.

FIG. 4 an ISO cut view of twin tubing rotor assembly FIG. 2.

FIG. 5 is a “D” detail views of seal ring assembly of FIG. 2.

FIG. 6 is a “C” detail views of universal sealable ball bearing of FIG. 2.

FIG. 7 is a front view of burner of FIG. 2.

FIG. 8 is a cross sectional view of burner of FIG. 7 along line B-B.

FIG. 9 is a cross sectional view of burner of FIG. 7 along line C-C.

FIG. 10 is a front view of an alternate of turbo pump of FIG. 1

FIG. 11 is a cross sectional view of electrical turbo pump FIG. 10 along line A-A.

FIG. 12 is a front view of electrical turbo pump of FIG. 10

FIG. 13 is a “C” detail view of in the bell drive ring of FIG. 12.

FIG. 14 is a cross sectional view of the alternate of FIG. 12 along line A-A.

FIG. 15 is a front view of an alternate of electrical turbo pump of FIG. 10

FIG. 16 is a cross sectional view of the alternate of FIG. 15 along line B-B.

FIG. 17 is a front view of two turbo pumps of FIG. 1.

FIG. 18 is a right side view of two turbo pumps in series FIG. 17

FIG. 19 is a cross sectional view of two turbo pumps of FIG. 17 along line B-B.

FIG. 20 is a left side view of two turbo pumps in series FIG. 17

FIG. 21 is an ISO cut of view of alterative of twin rotor assembly of FIG. 4

FIG. 22 is an ISO cut of view of alternate of turbo pump of FIG. 2

FIG. 23 is a front view of the alternate of FIG. 22

FIG. 24 is a cross sectional view of the alternate of FIG. 23 along line C-C

FIG. 25 is a “D” detail view of gas distributer of the alternate of FIG. 22.

FIG. 26 is an ISO cut of view of alternative of the union of FIG. 24.

FIG. 27 is a top view of an alternate of turbo pump FIG. 2.

FIG. 28 is a cross sectional view of alternative of FIG. 27 along line A-A.

FIG. 29 is an ISO cut of view of alternate of rotor assembly of FIG. 4

FIG. 30 is a cross sectional view of alternate of FIG. 27 along line B-B

FIG. 31 is a cross sectional view of alternate of FIG. 27 along line E-E

FIG. 32 is a “F” detail view of alternate of FIG. 28.

FIG. 33 is a cross sectional view of the alternative of FIG. 31 along line A-A.

FIG. 34 is an ISO, cut of view of alternate of rotor assembly of FIG. 4.

FIG. 35 is a cross sectional view of alternate of FIG. 33 along line A-A.

FIG. 36 is a “B” detail view of seal ring assembly of the alternate of FIG. 35.

FIG. 37 is a front view of burner of FIG. 33.

FIG. 38 is a cross sectional view of valve of FIG. 37 along line B-B.

FIG. 39 is a cross sectional view of valve of FIG. 37 along line C-C.

FIG. 40 is a side view of burner of FIG. 37.

### DESCRIPTION

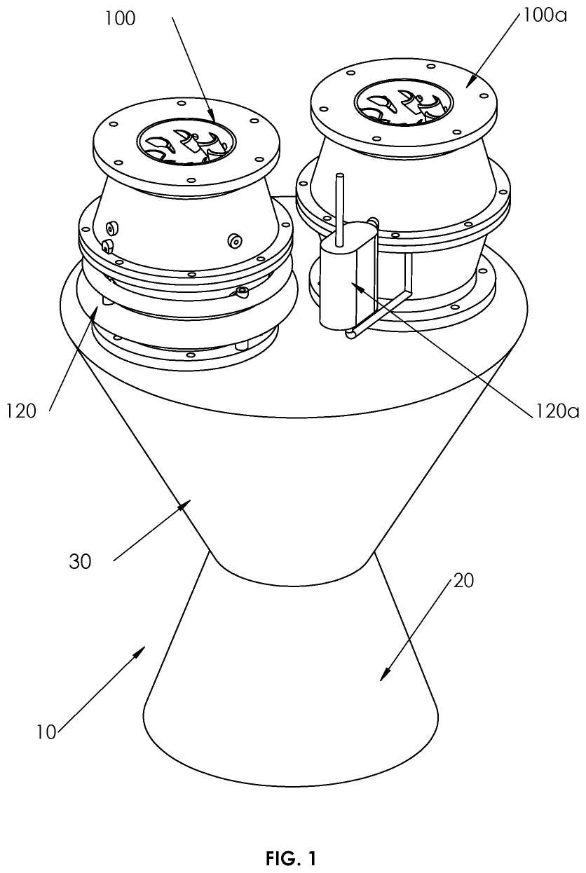

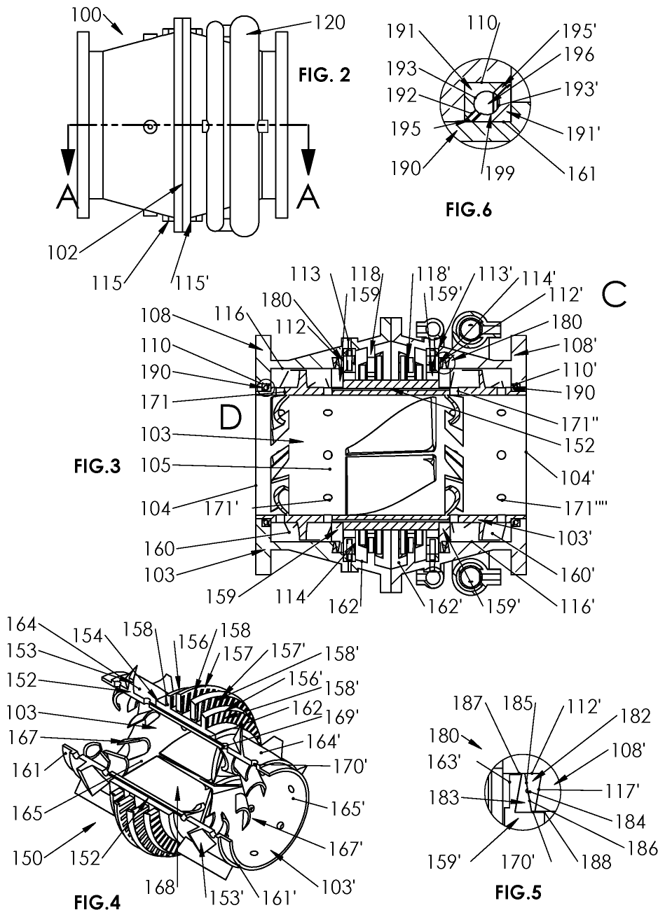

FIGS. 1-40 illustrate a shaft-less twin rotor turbomachine with a body assembly and a twin tubing rotor assembly movably disposed in the body assembly for providing fluid flow as a power receiver as well as a power producer and constructed in accordance with the present invention.

Referring FIGS. 1-11, a rocket engine 10 includes a gas powered turbo pump 100 with a gas burner 120 and an electrical turbo pump 100a with an electrical power 120a, a combustion chamber 30 and a nozzle 20, the turbo pump 100 comprises at least two ball bearings 190, two seal ring assemblies 180, a body assembly 102 having a main port 105 defined by an inlet port 104 and an outlet port 104′ and a burner 120, a twin tubing rotor assembly 150 movably disposed in the body assembly 102 has a left rotor 103, a right rotor 103′ and a union 152 with multiple axial holes between the left rotor 103 and the right rotor 103′, the body assembly 102 has a left body assembly 108 having a left rotor bore 116 engaged with the left rotor 103 to form a first left chamber 160 and a second left chamber 162 and a right body assembly 108′ having a right rotor bore 116′ engaged with the right rotor 103′ to form a first right chamber 160′ and a second right chamber′, the second left chamber 162 and the second left chamber 162′ can be constructed together or separately, the left body assembly 108 has a relief hole 115, a bearing bore 110, a seal ring bore 112, a front fixed wheel with gas injectors 114 and an inlet hole 113 connected to the front fixed wheel 114 and a back fixed wheel 118 with multiple blades 159, the inlet hole 113 is connected with the front fixed wheel 114, while the right body assembly 108′ has a relief hole 115′, a bearing step bore 110′, a seal ring bore 112′, a front fixed wheel with gas injectors 114′ and an inlet hole 113′ connected to the front fixed wheel 114′ and a second fixed wheel 118′ with multiple blades 158, the left rotor 103 has a step bore 154 with a left wall 159 and a front rotary wheel 156 with multiple blades 158 and a back rotary wheel 157 with multiple blades 158 sandwiching the second fixed wheel 118 with multiple blades 159 in the second left chamber 162, the right rotor 103′ has the same arrangement as the left tubing rotor 103, the union 152 can be constructed to support statically the rotors 103,103′ as an integral component, or as an independent part to support both the rotors 103,103′ with two ball bearings 190 dynamically or in a hybrid manner with magnetic coupling, when left incoming gases flow through the inlet holes 113 into the first fixed wheel 114 from the left side body assembly 103, hit the multiple blades of the first rotary wheel 156, then hit the multiple blades of the second fixed wheel 118, then bounce back and hit the multiple blades of the second rotary wheel 157,then flow out through the relief hole 115 and generates left reactionary forces on the left rotor 103, while right incoming gases flow through the inlet holes 113′ from the right side body assembly 103′ and act in the same way as the left coming gases in the left body assembly 103 and generate right reactionary forces on the right rotor 103′, as a result the left reactionary force and the right reactionary forces would cancel out each other without any side loads on the ball bearings 190 and greatly reduce erosion and vibration, moreover the rotors 103,103′ powered by the incoming gases not only can rotate clockwise and anticlockwise, but also rotate together or separately, so if the rotor 103 rotates clockwise, while the rotors 103′ rotor rotates anticlockwise, then both the left and right incoming gases come through the rotary wheels 157,157′ and become a pair of a clockwise rotation gas stream and a anticlockwise rotation gas stream, according to Newtown third law, the pair of rotating streams would reinforce the rotors 103,103 rotary movements as the rotary speech increase, if a conventional rotor with a rotary wheel, the rotor would take 55% of hot gas energy or if with two rotary wheels, the rotor would take up 70% of hot gas energy, if 70% of hot gas energy converts to the rotor 103,103, then 30% of the hot gas energy would waste and cause some damages between the rotary wheels 157,157′, but in this case, the 30% of energy would be reused to power the rotors 103,103 one more time at the relief stage, so the turbo pump 100 would reach the high efficiency by more 90% to 95% with much small volumes, less erosions and vibrations, there is no a single turbo pump in the world has the those features and benefits.

Each of the rotors 103,103′ is respectively disposed in the left body assembly 108 and the right body assembly 108′, the union 152 with a set of internal blades 168 supports both the rotors 103,103′ statically to impel incoming flows or dynamically to mix incoming flows, the union 152 is a key for product modulation, each rotors 103,103 housings can be made as standard products, then based on applications, the union 152 can be increased or decreased by the length or inside diameter or outside diameter and constructed as an integral part by welding, press fit gluing or with one or two ball bearings 190 for independent control of the rotors 103,103′ or with a magnetic coupling in a hybrid manner, the union 152 can be made out of different materials form that of the rotors 103,103′, because the thermal difference between the hot gas and cryogenic fluids can cause thermal shock and damage the rotors 103,103′, so the union152 is designed to provide a thermal shelf to prevent the rotors 103,103′ from thermal shock, the left rotor 103 has multiple radial holes 171 and a rotary wheel with blades 167 defined by features of centrifugal blades and axial blades dividing incoming flows in the main port 105 into two flow zones, a high power zone and a lower power zone, the zones are defined by the inside diameter of blade 167.

Tests for this invention were conducted with a conventional rotor having range of 1 to 12 blades, there are two extreme cases, (1) as the rotor speeds up with the 12 blades, the blades soon become a wall, so there is almost no flow to pass (2) while the rotor speeds up with 0 to 1 blade, there is almost no flow to pass due to lack of converting power from the rotor, why did the rotor cause the two results? because the conventional rotor is designed to add blade angularly so when the rotor speed up, eventually the number of blades would block the flow path, the same problems happen in the wind turbine blades as well as marine propeller blades, moreover if the rotor convert all 100% given power to the flow, then the rotor would stop, so the conventional rotor never reach high efficiency more than 50% to 55%.

The two zones are radially designed and solve the conventional rotor inherent problem, the high power zone is designed to pass high power flow from a large part of diameter of the blades 167 and more number of blade, which generate more power, some of the incoming flows is impelled up into the first rotor chamber 160 through the radial holes 171, some of the incoming flows is impelled forward in the main port 105 in the low power zone, while the left rotor 103 also has multiple radial holes 171′ and a left rotary wheel with axial blades 153 on an external surface 164 to further impeller the upcoming flow in the first rotor chamber 160, then push back into the main port 105 through the radial holes 171′, then the high velocity flow get back into the low power zone, so a perfect vortical flow is formed between the inlet 104 and the radial holes 171′ as the rotor 103 speeds up with 80% to 90 of input gases power, the pressure gradient is formed between the low power zone and high power zone according to Bernoulli equation, as a result the rotor 103 would suck more flows than the diameter of main port 105, so an inlet adapter from Lox or fuel tank can be much larger, it is also very useful feature in the wind turbine or marine propeller applications, so incoming flows pass the union 152 either with or without a mixer 168 and reach at the right rotor 103′, the whole process repeats again like in the left rotor 103, the incoming flows reach at the first right chamber 160′ through radial holes 171″ as well as the axial holes 152 and are impelled through blades 153′ as well as pass blades 167′, and become a high pressurized and high flow rate outgoing flows, due to the flow streams from radial holes 171′″ at the outlet 104′, so there is no need diffuser unlike centrifugal turbo pump, more powerful feature is that the blades wheel 167 and the blades wheel 167′ can be constructed respectively with left or right or one left and one right, so if the rotor 103 rotor rotates clockwise with the left blades wheel 167, while the rotor 103′ rotates anticlockwise with the right blade wheel 167′, the incoming flows would pass from the inlet 104 to the outlet 104′, if the arrangement is the other way around, then the incoming flows would pass from the outlet 104′ to the inlet 104, why it is so important feature, because it would great reduce noise, vibration and cavitation as well as wake rotation in the downstream, all those inherent problems are related to the conventional turbomachine, specially the wake rotation in downstream is an inherent problem for even the most advanced low noise submarines.

A seal test for this invention was conducted with a tester having a cylinder bore engaged with a shaft by a radial gap, the tester has an inlet end with a pressurized fluid and a an outlet end (pressure=force/area=force×distance/area×distance=work/volume of the gap=a fluid work density), so we know the leak of flow because the flow does the work, so if the flow does not work, there is no leak!, now we know there are two conditions which cause leak together, a gap and a pressure difference, the test was conducted with the tester having a conical bore engaged with a conical shaft by a radial gap, the shaft is driven by a motor, as the motor speed up or the conical angle increase or the gap reduces, the pressurized fluid would move slower and slower from the inlet to the out let and eventually stop.

The left rotor 103 has a left wall 159 with a bore 170 between the first left chamber 160 and the second left chamber 162, the right rotor 103′ has a right wall 159′ with a bore 170′ between the first right chamber 160′ and the second right chamber 162′, one of the seal assemblies 180 is disposed between the bore 170′ and a body bore 112′ of the right body assembly 108′, the seal ring assembly 180 has at least one fixed V seal ring 182 with a conical surface 185 and at least one dynamic V seal ring 183 with a mated conical surface 186 engaged with the surface 185 in axial directions for dynamic seals, the fixed V seal ring 182 installed with the seal ring bore 112 of the body assembly 108 with a press fit has a low gap 188 with the step bore 170′ of the right wall 159′, the dynamic V seal ring 183 installed with the right wall 159′ with a press fit has a top gap 187 with the bore 112, the seal ring assembly 180 has at least one groove 184 between the fixed seal ring 182 and the dynamitic seal ring 183 to collect fluid or sealant, in addition, a second of the V seal rings 183,182 can be added to provide spring functions or heat exchange, so as the rotor 103′ rotates, the fixed seal ring 182 stays with the body assembly 108′,while the dynamic seal ring 183 stays with the rotator 103′, there are three factors; centrifugal force, tangential speed, rotational speed with the dynamic V seal ring 183, a speed of OD of seal rings 182,183 is more higher than that of ID of seal ring 182,183, the rotors 103, 103 is defined by X and Y directions, X is an axle of the rotors 103 and 103, the centrifugal force is defined by Y direction, the interface between V wedge rings 182, 183 is defined by an angle from X, as the seal test indicates as the angle change away from Y direction, the leakage gradually stops, so the dynamic V seal ring 183 would not carry fluid without any blade when rotating, while the Fixed V seal rings 182 is stationary, there is no stable gap to be established, moreover the boundary layers of fluid on seal rings 182,183 would remain, as Bernoulli's equation states that higher speed, lower the pressure, so the fluid in the top gap 187 would not go to the low gap 188 due to a negative pressure gradient, while the fluid at the low gap 188 can go to the top gap 187, but it must get through the interfaces between surfaces 185 and 186, there is a little mass of the fluid to be effected by the centrifugal force or fluid pressure, or the fluid can do a little work, as we know the formula (pressure=force/area=force×distance/area×distance=work/volume of the gap), it would not move up, moreover the groove 184 is a fluid equalizer, so even the fluid passing through the low gap 188 would stay at the groove 184 due to fluid surface tension, if the fluid is a gas, then sealant between surfaces 185 and 186 would provide liquid seal as well, sealant can be used for high temperature or cryogenic conditions, so no fluid can leak from top gap 187 to low gap 188 or vice versa, the seal assembly 180 is a positive seal to sustain loads and can be used as a static seal in high vibration applications, while most of spring energized seal ring or shroud seal ring cannot sustain the severe loading even for static seals in high speed or high vibration machines, because they just cannot keep constantly seal contract around 360 degree or pulse dynamic leakage.

The left body assembly 108 has a bearing bore 110, the left rotor 103 has a step bore 161, the right body assembly 108′ has a bearing bore 110′, the right rotor 103′ has a step bore 161′, the two ball bearings 190 are respectively disposed between the bearing bore 110 and the step bore 161 and between the bearing bore 110′ and the step bore 161′, the ball bearing 190 has a left ring 191 and a right ring 191′ and multiple balls 196, a left wedge insert ring 195 and right wedge insert ring 195′, the left ring 191 has a conical surface 192 and a ball groove 193, the right ring 191′ has a conical surface 192′ and a ball groove 193′, the multiple balls 196 are disposed between ball grooves 193′,193, the left insert ring 195 and the right insert ring 195′ respectively disposed between wedge surfaces 192,192′ have at least one set of round slots to position the balls 196, the insert rings 195,195′ are made out of soft materials including bronze, aluminum, engineering plastics with sealant or grease or the fluid like lox or fuel are placed between left ring and right rings 191,191′, as the twin tubing rotor assembly 150 rotates, insert ring 195,195′ are disposed between the rings 191,191′ to prevent sealant or grease 199 or other fluids from coming out, the seal theory is the similar to seal ring assembly 190, so the ball bearing 190 not only can support radial and axial loads, but also provide seals, additionally because diameter of the step bore 161 is much larger than any shaft diameter, so there are more balls, more contact surfaces to support loads than the conventional ball bearing, the overheat and vibration are eliminated or reduced greatly.

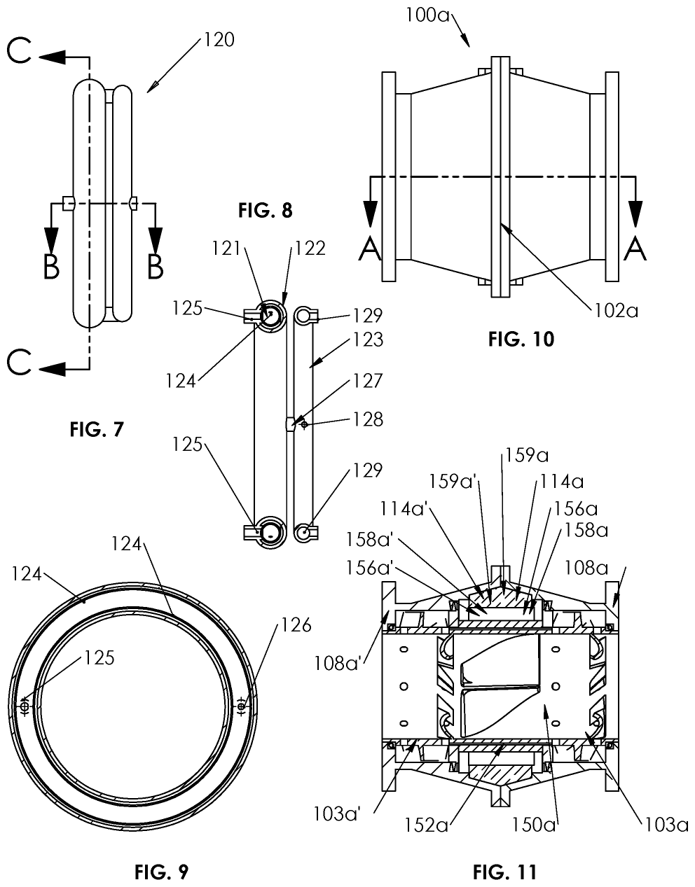

Referring to FIGS. 7 to 9, the torus burner 120 has at least one Lox torus tubing 121, at least one burning torus tube 122 and, the Lox torus tube 121 and the expansion torus tube 122 can be concentric or intersected and at least one thermal expansion torus tubing 123, the Lox torus tubing 121 has multiple inlet holes 125, 126 and multiple outlet holes 124 to the expansion torus tube 122, fuel or (TEA-TEB) is injected into multiple burning tubes 127 with igniters and multiple layer, outlet holes 129 are connected to the inlet holes 113 and 113′, the burning tube 127 is defined by a small diameter with tube 122 and a large end with the tubing 123, the tubing 123 is larger volume than that of tubing 122, addition of the torus burners 102 can be added in a concentric way or in a series, so in comparison with the cylinder burner, the torus burner 120 is simpler and easy to establish flare and evenly distribute heat with fuel and oxygen in a controllable way, the Lox torus tube 121 and the expansion torus tube 122 can be separated with burner tubes127 in comparison with other pre burners, this burner is much smaller and lighter and safer.

Referring FIGS. 10-11, the electrical turbo pump 100a has a body assembly 102a and a tubing rotor assembly 150a and an electrical power supply 120a, the body assembly 102a has a left body assembly 108a and a right body assembly 108a′, the twin tubing rotor assembly 150a has a left rotor 103a inserted in left body assembly 108a to form a first left rotor chamber 160a and a second left rotor chamber 162a, a right rotor 103a′ inserted in the right body assembly 108a′ to a first right rotor chamber 160a′ and a second right rotor chamber 162a′ and a union 152a, the left body assembly 108a has an fixed wheel 114a with an electrical stator 159a, the left rotor 103a has an external rotary wheel 156a with electrical rotor 158a engaged with the electrical stator 159a for generating rotations clockwise or anticlockwise, the right body assembly 108a′ has a fixed wheel 114a′ with an electrical stator 159a′, the right rotor 103a has an external rotary wheel 156a′ with an electrical rotor 158a′ engaged with the electrical rotor stator 159a′ for generating rotations clockwise or anticlockwise, so the rest of the electrical turbo pump 100a has the similar structure to the gas powered turbo pump 100, moreover the rotors 103a,103a′ can rotate clockwise or anticlockwise together or separately, the rotors 103a can rotate clockwise, while the rotors 103a′ can rotate anticlockwise and vice versa, as a result a pair of clockwise rotary magnetic flux and anticlockwise rotary magnetic flux reinforce the left rotor 103a and the right rotor 103a′ with 10 to 20% more output as the speed of the rotors 103a,103a′ increase, finally the rotator 103 and rotor 103a′ can work together or the rotator 103′ and rotor 103 a can work together with the union 152a having a wall, so the hybrid rotor assembly can be used for quick shutting down in an emergence without causing water hammer in a downstream system, instead of shutting down prevalves in an rocket engine, because the clockwise flow and anticlockwise flow cancel each other out, while shutting down the prevalve can cause water hammer without any counter balanced flow, in addition electrical motors or electrical generators based on the electrical stators 159a,159a′ and the electrical rotors 158a′,158a can be installed in back of the rotors 103a,or 103a′ as shown or front of the rotors 103a,or 103a′, so a new fluid powering method is created with three stage powering (1) the main port 105a, a pair of the rotary wheel on the left and right rotors 103a,103a′ with blades defined by axial and centrifugal features (2) in the first rotor chambers 160a,160a′, a pair of the rotary wheel on the left and right rotors 103a, 103a′ with axial features (3) in the second rotor chambers 162a,162a′, a pair of wheels on the left and right rotors with blades defined by (a) axial and centrifugal features (b)) axial features (c) centrifugal features, the rotors 103a,or 103a′ can work in overlap to power the fluid with two stage centrifugal features, or head to head with those features, it can be also arranged with two inlets on sides and one outlet in the middle as well, so they are so efficient and can generate more fluid power about 20% than any fluid power machine in the world.

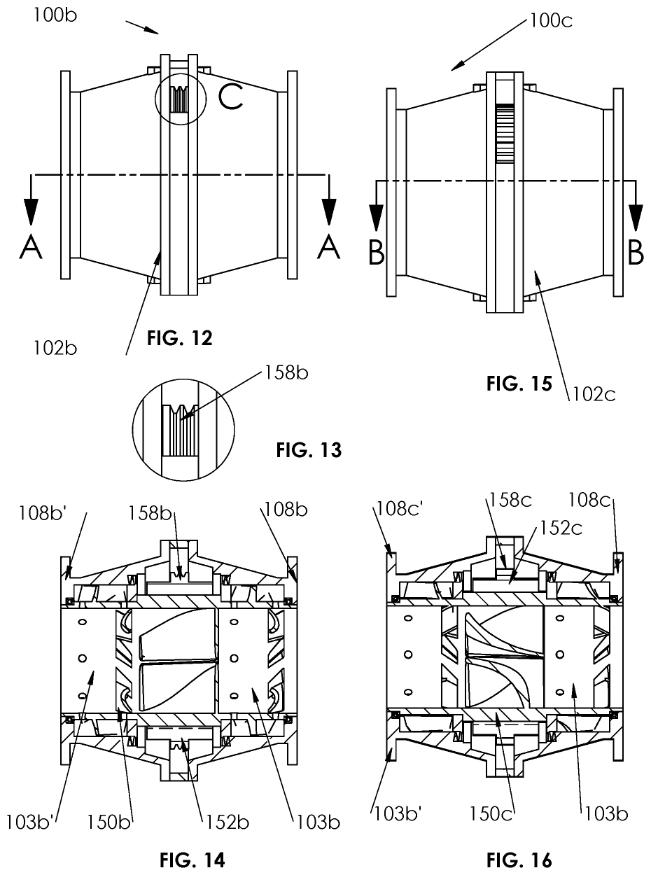

Referring FIGS. 12 -14, an alternate turbo pump 100b of the electrical turbo pump 100a with an external power, turbo pump 100b has a body assembly 102b, a twin tubing rotors assembly 150b disposed in the body assembly 102b, the body assembly 102b has a left body assembly 108a and a right body assembly 108b, the tubing rotor assembly 150b has a left rotor 103b and a right rotor 103b′ and a union 152b with a bell ring 158a to connected to with the external power.

Referring FIGS. 15 -16, an alternate turbo pump 100c of the electrical turbo pump 100a with an external power, the turbo pump 100c has a body assembly 102c, a twin tubing rotor assembly 150c disposed in the body assembly 102c, the body assembly 102c has a left body assembly 108c and a right body assembly 108c′, the tubing rotor assembly 150c has a left rotor 103c and a right rotor 103c′ and a union 152c with a geared ring 156c to connected with the external power.

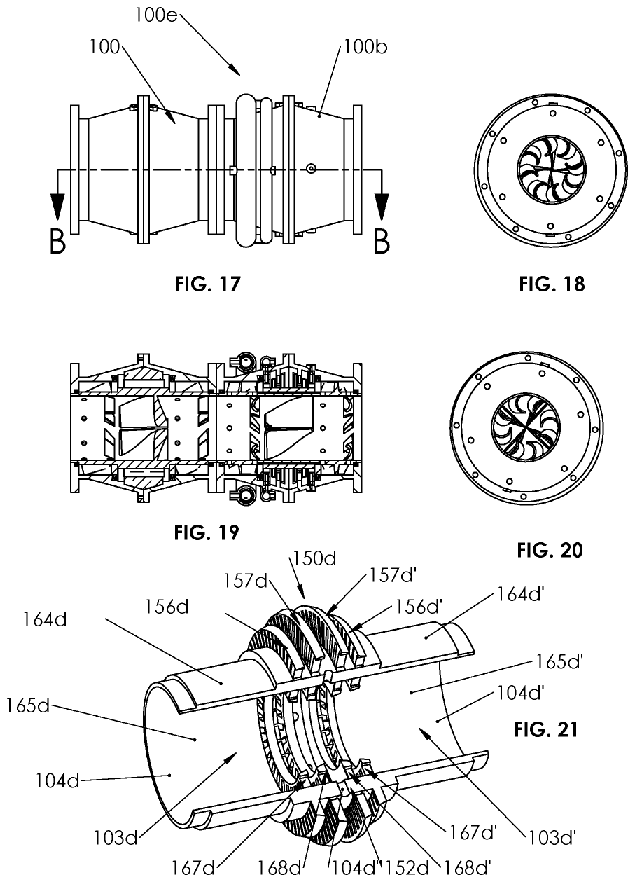

Referring FIGS. 17-20, hybrid turbo pump 100e is a combination of the gas powered turbo pump 100 and the electrical turbo pump 100a in series, and the electrical turbo pump 100a can be used as an alternator when the gas powered turbo pump 100 generate too much power.

Referring to FIG. 21, a twin tubing rotor assembly 150d for stream turbines, as an alternative of the twin tubing rotors assembly 150, the twin tubing rotor assembly 150d has a left rotor 103d and a right rotor 103d′ and a union 152d with multiple radial holes 104″, the left rotor 103d has an external surface 164d having a front and back fixed wheels 156d, 157d, and an internal surface 165d having a front and back fixed wheels with blades 167d,168d, the right rotor 103d′ has an external surface 164d′ having a front and back rotary wheels with blades 156d′, 157d′, and an internal surface 165′ having a front and back rotary wheels with blades 167d′,168d′, a left internal fixed wheel with blades is placed between wheels 167d and 168d is not shown, and a right internal fixed wheel with blades is placed between wheels 167d′ and 168d′ is not shown, because they are constructed with the body assembly 102d, so when two incoming gases or steams come into inlets 104d,104′ hit wheels 167d, 168d as well wheels 167d′, 168d′ then pass through relief holes 104d″, the wheels 156d,157, 156d′,157d′ would do the same, so a pair of electrical power generators with heat exchanges can be added respectively with the left rotor 103d and the right rotor 103d′ in the front, which can rotate together or separately, then two relief streams as a pair of clockwise and anticlockwise rotations can generate more power than any steam turbines in the world, it can double electricity with the highest thermal efficiency to recycle all heats, less vibration, balanced side loads and redundancy, and not only revolutionize steam turbines but also electrical generators without a large shaft and shaft coupling misalignments, think about what if a 50,000 kilowatts standard steam turbine and a generator replaced by this shaft less twin rotor turbomachine, it produces additional output 30,000 kilowatts with much less weight, what a saving!!!!!!!, moreover, if two of this steam turbines are installed in the submarine, it not only reduce the vibration by eliminating coupling and a large and long shaft between the steam turbine and propeller, but also eliminate rotary vibrations with a pair a clockwise rotation and a anticlockwise rotation form steam turbines 100d.

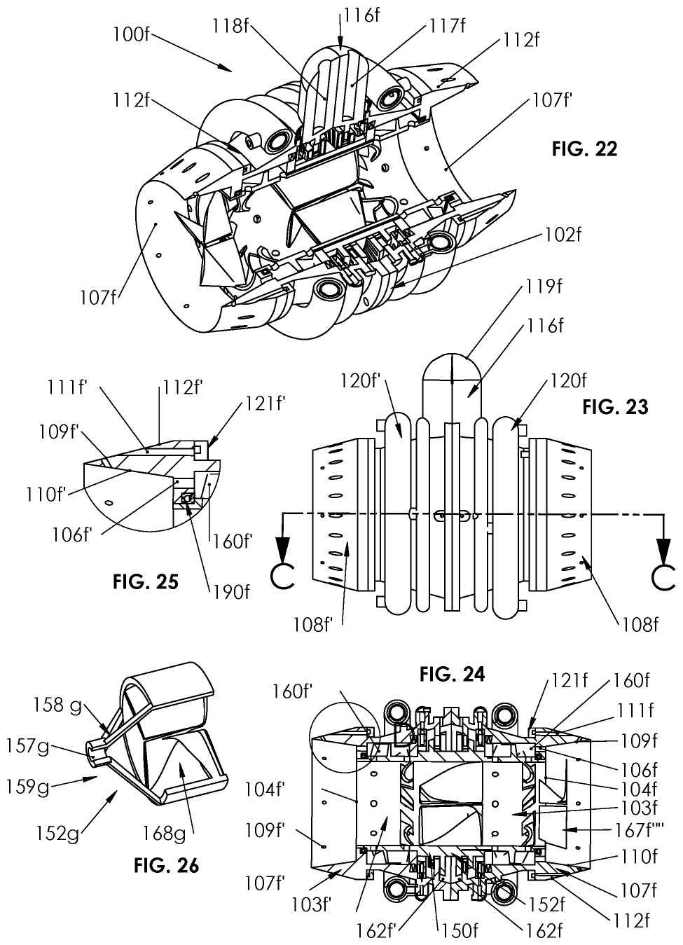

Referring FIGS. 22-25, a self-powered propeller 100f, an alternate of turbo pump 100, the propeller 100f includes two burners 120f,120f′ and two gas relief rings 121f and 121f′, a body assembly 102f has a joint control shaft 116f having a fuel line 117f and an airline or oxygen line 118f to respectively connect two burners 120f,120f′ and a twin rotors assembly 150f with a union 152f disposed in the body assembly 102f for generating thrust, the body assembly 102f has a left body assembly 108f and a right body assembly 108f′, the left body assembly 108f has a left conical extension 107f with multiple cross holes 109f between surfaces 112f and 110f, the left conical extension 107f has much larger inside diameter than that of inlet port 104f, so the rotor 103f can suck more fluids and generate more thrust, and vortical flows are created along with pressure gradients between surfaces 112f and 110f, unlike the turbo pump 100, the propeller 100f is a moving device, so any front pressure gradient would hamper the propelling, the cross holes 109f would reduce the tip pressure resistance, the left body assembly 108f also has multiple high power holes 106f to connect fluid between chamber 160f and the left conical extension 107f to generate more powers, the right body assembly 108f′ also has multiple high power holes 106f to connect fluid between chamber 160f′ and a right conical extension 107f′, when high power fluids at the first rotor chamber 160f′ relieve to the conical extension 107f′ through multiple 106f′ holes and automatically convert to high pressure fluid stream due to increase of cross section area at the right conical extension 107f′ and provide a high power zone stream to prevent downstream expansions, wake vortex as well as prevent the low power zone stream from external flow disrupt, while the right body assembly 108f′ has a right conical extension 107f′ with multiple cross holes 109f′ between surfaces 112f′ and 110f′ to generate more bubble and reduce wake rotation, while the fluids in the low power zone provide large amount of the mass, because the thrust is dependent on the mas flow rate, flow velocity and flow pressure, in addition the propeller 100f combine the best features of axial propeller and centrifugal propeller, by the way, there is no singe centrifugal propellers created before this invention, the left rotor 103f can be constructed with high pitch blades, while the right rotor 103f′ can be constructed with low pitch blades for speed control, moreover the gas burner 120f can be connected with the hot gas relief ring 121f to generate thermal and dynamic bubbles to create supercavitation to reduce fluid resistance, or the gas burners 120f, 120f′ can be connected with the hot gas relief ring 121f′ to generate more dynamic and thermal thrusts, according to thermodynamics that states the relations among pressure, temperature and volume and the conservation of energy, in theory, a moving marine vessel is a machine to separate fluid molecules, as we know a moving object moves much easier in air than water, the difference is that the distance among air molecules are much larger than that in the water molecules, any heat around the marine vessel would increase the fluid molecule distances and move much easily, the gas powered propeller 100f can be added with a streamline cover like a jet engine to reduce fluid resistance, the twin rotors assembly 150f has a left rotor 103f and a right rotor 103f′ and a union 152f with a wall to isolate the left rotor 103 from the right rotor 103′, the propeller 100f can be powered by hot gas supplies as well electrical supplies, the rotor 103f can be driven by electrical power, while the right rotor 103f′ can be driven by hot gas power, so at low speed, the gas power rotor 103f′ can charge the electrical rotor 103f like an alternator, for a quick start, the left rotor 103f can take a lead to start propeller 100f, additional front blade wheel 167f″ is constructed with the rotor 103f or the left body assembly 108f to prevent solid subjects from damaging the twin rotor assembly 150f, finally the cylindered joint shaft 116f with two fluid lines 117f,118f can be installed on a side of a ship or submarine and two shaft 116f can installed on a back of ship, they would greatly increase mobility of the ship or boat or amphibious boat equipped with the propeller 100f, because the cylindered joint shaft 116 can be operated at a horizontal position or vertical position or between and can be changed at any time from top to bottom, or right to left to power amphibious boat at shallow water or land, if two propellers 100f are installed on a left and right near the center of gravity or three propellers 100f with 120 degree apart with boat, submarine or torpedo.

According to research reports about Shortfin mako shark, Shortfin mako shark can reach speeds as high as 60 mph (96.5 kph), the secret is that two muscles near the two right and left fins generate most of striking forces during attacking, so if a submarine is defined on X,Y Z axis, a front to back of the submarine is located on Y axis, left to right of the submarine is located on X axis, top to bottom of the submarine is located on Z axis, the submarine or marine vehicle can mimic Shortfin mako shark structure, two left and right propellers 100f can be installed near a middle body of a marine vehicle on X axis (a center of gravity with range between 180 to 120 degree apart) which mimic the left and right fins of the shark, they should be installed in front of ballast tanks access ports, two back propellers 100f with top and bottom shaft on Z axis is installed at the back to mimic the tail of the shark, and two back propellers 100f can be wiggled through the control shafts, so this submarine or torpedo would have six freedoms in sea, because two left and right propellers 100f can rotate around X axis about 180 degree, so the submarine can rotate around round X axis about 180 degree clockwise and anticlockwise or more, if the left and right propellers 100f in an opposite directions rotates 180 degree at the same time, then the submarine can rotate around Y axis, if one of two left and right propellers 100f stops, then the submarine can rotate around Z axis, or the back propeller 100f can rotate around Z axis, rest of translations would be much easy, there is no such submarine ever created!!, which would outsmart and out pass Shortfin mako shark!! Finally the propeller wake is a big enemy for submarine stealth function, what is the inherent problem for all propelled submarines or ships, what the propeller 100f does is to cancel out the wakes with a pair of a clockwise wake and anticlockwise wake, and multiple even number of a pair of propellers 100f with left and right blades can be installed at back of submarine in a concentric manner, so they would cancel out the wakes, or with a more brave try, if a submarine has 6 of propellers 100f, each of propellers 100f has 5 speeds selection with the left rotor 103f, 5 speeds selection with the right rotor 103f′, so the combination would be 5*5*6=150 with Fourier transform and AI, the submarine can mimic a moving behavior of any large sea creature and become a part of nature to hide from enemy instead of fighting against nature.

Referring FIG. 26, an externally powered propeller 152g of an alternative of the union 152 has internal blade wheel 168g, a front support 159g having three link bars158g and a shaft adapter 157g, the link bars158g not only connect the shaft adapter 157g with the blade wheel 168g,but also prevent solid subject from damaging the internal blade wheel 168g, although the propeller 150g does not have centrifugal feature on the blade wheel 168g, but has two power zone design feature, so in comparison with the simple boat propellers, the propeller 152g not only improves the efficiency about 15 to 35% due to smooth edge of blades and the hollow center, but also prolong the blades life without the cavitation on the edge of blades and protect the blades from tangling fishing wires or solid subjects due to the robust tubing and blades joint structure, two or more propellers 152g can be used in series or parallel manner.

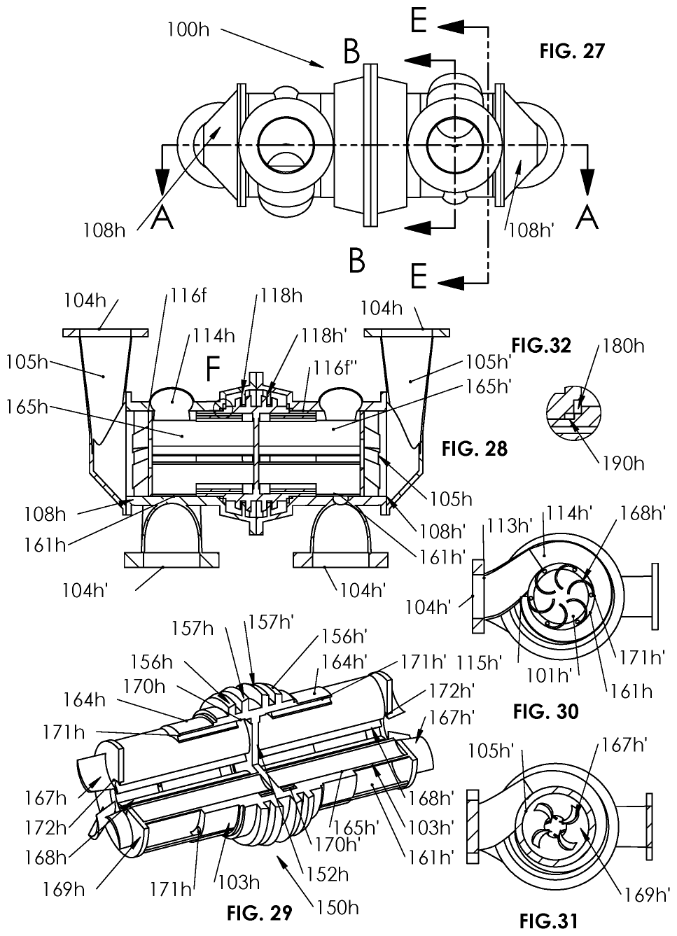

Referring FIGS. 27 to 32, a turbo pump 100h, an alternate of turbo pump 100 has a body assembly 102h with two ball bearings 190h and two seal assemblies 180h and a twin rotor assembly 150h disposed in the body assembly 102h for proving high power flows, the body assembly 102h has a left body assembly 108h with a bore 116h, an inlet 104h and outlet 104h′ and a right body assembly 108h′ with a bore 116h′, an inlet 104h and outlet 104h′, the twin rotors assembly 150h has a left rotor 103h inserted in the left body 103h to find a first rotor chamber 160h and a second rotor chamber 162h, a right rotor 103h′ inserted in the right body assembly 108f′ to form a first right rotor chamber 160h′ and a second right rotor chamber 162h′ and a union 152h with a wall defined by flat shapes, conical shapes and spherical shapes, the left body assembly 108h has the first rotor chamber 160h having a body chambers 105h connected with the inlet 104h and a volute groove 114h defined by multiple various ellipse cross sections 115h and one round end section 113h to connect to outlet 104h′ and active wheel with blades 168h, the left rotor 103 h has an internal surface 165h, an external surface 164h, the internal surface 165h has blades 168h extending to blade plate 169h with a bore 172h and blades 167h defined by features of a backward centrifugal blades and axial blades, an opening 161h having multiple through multiple holes 171h to an internal groove 170h, the external surface 164h has two rotary wheels with blades 156h and 157h to respectively sandwich the fixed wheel with blades 118h in the second left rotor chamber 162h, as incoming fluids enter inlet 104h to chamber 105h, blades 167h rotate anticlockwise push the fluid inward and into a center hole 172h at a first stage, so a vortex and pressure gradient are created, more flows would be sucked in, then the incoming fluids come to the second chamber 101h, the forward blades 168h push the fluid radially out into the volute groove 114h through the opening 161h, since the ellipse section area is larger than the same radial round section area about 8% more, at a third stage, a part of blades 168h near the union 152h generate more fluid into groove 170h extending the volute groove 114h through multiple through holes 171h and inject more high pressure flow into the volute groove 114h, it resolves the cavitation at the entry of volute groove 114h, the right rotor 10h3′ and the right body assembly 108h′ work in the same way as the left rotor 103h and the left body assembly 108h, since the left rotor 103h and the right rotor 103h′ are symmetrical, there is no side load on the bearings 180h or seal assembly 190h, the bearing 190h and seal assembly 180h provide dual seals, moreover e there is no need for a diffuser in the outlet 104h′, because the holes 171h are located around the cylindrical surface 164h and provide high power fluid, the high power zone and low power zone is defined by the diameter of the bore 172h, while the incoming fluid through bore 172h is located in the low power zone, in short, the turbo pump 100h has more flow rate and output pressure by 30% in comparison with the same weight of the conventional turbo pump, most import difference is that there is no priming issue, because in the body chamber 105h, the incoming fluid enter into the center hole 172h impelled by backward blades 167h, so it provides not only full lift power in the second stage of the volute groove 114h, but also generates high efficient, rotary flow with the optimized shape of the wall, the key differences between the conventional centrifugal pump and this turbo pump 100h are the volume and weights, this turbo pump 100h has much less weight and carry more volume than the conventional centrifugal pumps do and can produce more flow power as a pair together without the internal wall.

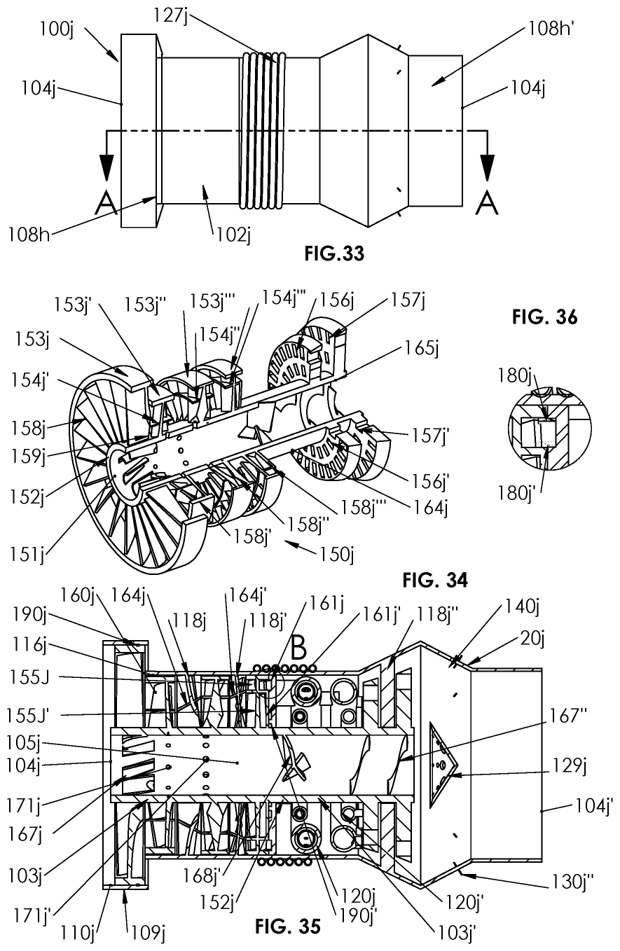

Referring FIGS. 33-36, a thermal jet engine 100j or self-propelled ramjet, an alternate of turbo pump 100, the jet engine 100j has a body assembly 102j with an main port 105 j defined by an inlets 104h and outlets 104j′ and a twin tubing rotor assembly 150j disposed in body assembly 102j with two ball bearings 190j, 190j′ and two seal ring assemblies 180j, 180j′ for generating thrust, each of two seal ring assemblies 180j, 180j′ works as the same as the seal ring assembly 180 except that the seal ring assembly 180j has at least one fixed V seal ring 182j with a conical surface 185j and at least one dynamic V seal ring 183j with a mated conical surface 186j engaged with the conical surface 185j in radical directions, while the seal ring assemblies 180 has the fixed V seal ring 182 engaged with the dynamic V seal ring 183 in axial directions, the body assembly 102j has a left body assembly 108j and a right body assembly 108j′, the left body assembly 108j has a front extension 109j with a fan bore 110j, a body bore 116j and a first fixed blades wheel 118j with a segment ring 164j, a second fixed blades wheel 118j′ with a segment ring 164j′, a high pressure storage 161j and a low pressure storage 161j′ as well as a heat exchanger 127j, the right body assembly 108j′ has a combustor 140j with a umbrella starter 129j with multiple holes as well as fuel injectors/igniters 130j, a top burner 120j connected with the high pressure storage 161j and a bottom burners 120j′ connected with the low pressure storage 161j′ and a fixed wheel with blades 118j ″, the twin tubing rotor assembly 150j has a left rotor 103j and a right rotor 103j′ and a union 152j with a set of blades168j, the left rotor 103j has a cylinder internal surface 165j, the cylinder external surface 1065j has a rotary fan blades wheel 158j with an edge ring 153j, a second rotary axial-centrifugal blades wheel 158j′ with an edge ring 153j′ and a segment ring 154j′, a third rotary axial-centrifugal blades wheel 158j″ with an edge ring 153j″ and a segment ring 154j″, a forth rotary axial-centrifugal blades wheel 158j′″ with an edge ring 153j′″ and a segment ring 154j′″, so the fixed blades wheel 118j with a segment ring 164 is sandwiched by the second fixed, axial-centrifugal blades wheel 158j′ with the edge ring 153j′ and the segment ring 154j′, the third rotary axial blades wheel 158j″ with the edge ring 153j″ and the segment ring 154j″, while the second fixed blades wheel 118j′ with the segment ring 164′ is sandwiched by the third rotary, axial-centrifugal blades wheel 158j″ with the edge ring 153j″ and the segment d ring 154j″, the four rotary, axial-centrifugal blades wheel 158j′″ with the edge ring 153j′″ and the segment ring 154j′″, so an air chamber 160j between the left body assembly 108j and the left rotor 103j is divided by the segment rings 154j′, 154j|, 154j′″ and 164j,164j′ into a high pressure chamber 155j and a low pressure chamber 155j′, the high pressure chamber 155j is connected with the high pressure storage 161j, the low pressure chamber 155j′ is connected with the low pressure storage 161j′, so air streams pass through the first fan wheel 158j and enter the high pressure chamber 155j and are gradually compressed to the high pressure storage 161j as a first stream and enter the low pressure chamber 155j′ and are gradually expanded to the low pressure storage 161f as a second stream, the left rotor 103j has an internal cylindrical surface 164j having at least one rotary blades wheel 167j defined by the combination of centrifugal and axial turbomachine features as well as multiple radial holes 171j, 171j and defining a high power zone and a low power zone, a third air stream pass into the inlet 104j enter the main port 105j and divided into second stream impelled into multiple radial holes 171j, 171j into low pressure chamber 155j′ and go to combustor 140j, so according to thermodynamics, P1*V1/T1=P2*V2/T2, as the air in high pressure chamber 155j is compressed by reducing, the volume, T2 in high pressure chamber 153j would increase, while the air in low pressure chamber 155j′ is gradually expanded, the T2 in low pressure chamber 155j′ would increase with axial compression-centrifugal acceleration functions as well as through the conduction and radiation, the temperatures between low pressure chamber 155j′ and high pressure chamber 155j would reach at an equivalence point, the third air stream in the main port 105j pass the blades 168j, the right rotor 103j′ has an internal surface 164j having a rotary wheel with helical blades 167j′ and an externally cylindrical surface having a first rotary wheel 156j with a top set of blades and a second rotary wheel 157j with a top set of blades and a first rotary wheel 156j′ with a low set of blades and a second rotary wheel 157j′ with a low set of blades, the jet engine 100j has a gas turbine made out of 156j,157j,118j″ connected with the high pressure storage 161j, a steam turbine having wheels 156j′,157j′ and 118j″ connected with the low pressure storage 161j′, so the first air stream in the high pressure chamber 155j, the second stream in the low pressure chamber 155j′, the third air stem in main bore 105j has the lowest pressure and temperature, but high velocity as a jet plane speeds up, so the air in high pressure chamber 155j goes into the burner 120j to the gas turbine made out of 156j,157j,118j″ with top blades generate the most of rotation power and thrust, the air in low pressure chamber 155j′ goes into the burner 120j′ with alcohol fuel and hot water from the heat exchange 127j into the steam turbine with 156j′,157j′,118j″ and generate the rotation power and thrust, finally the third air stream in the main bore 105j would hit the conical umbrella starter 129j with multiple holes and igniters to slow down the air speed to ignite fire with the fuel injectors/igniters 130j and generates only thrust, the umbrella starter 129j can be constructed with the rotor 103j′ or the right body assembly 108j′, while the fuel from injectors 130j hit umbrella 129j to mix with the air to burn, because the umbrella 129j rotates with the tubing rotor assembly 150f and evenly distribute radially and allow fire to go in spiral stream to generate maximum energy in the combustor 140j as well as cool down the temperature, so the three air streams with three burners would create the most efficient jet engine over all jet engines in today market, at a takeoff stage, or all three burners 120j,120j′ and 140j work together, while in air, the two burners 120j′ and 140j can work together with alternator to store energy and to cool the combustor 140j, in case the air in the high pressure storage 161j surges, relief valves can be installed between the high pressure storage 161jj and low pressure storage 161j′ or the main bore 105j, so no energy waster unlike conventional jet engines, while the conventional nickel and titanium alloys can be used without expensive materials at much lost cost, on the contract, the temperature in conventional jet engines at high pressure section is about 600 to 900 c even with air cooling, while at combustion stage, temperature can reach at about 1200 c, so far the solution is to use expensive materials instead of harvesting the heat with thermodynamic design, finally the alcohol fuel is most environmental friendly like Ethanol fuel, chemical reaction with oxygen is C2H5OH+3O2→2CO2+3H2O+heat, while the Kerosene chemical reaction is 2C12H26(l)+37O2(g)→24CO2(g)+26H2O(g)+heat, they have the similar densities 0.7893 g/cm3, 0.81 g/cm3, so they are easy to store with existing size of fuel tanks as well, finally the thermal jet engine 100j can be used as a self-propelled ramjet, all ramjets are need a carrier to reach high speed in the air, so with some modification of the left body assembly 108j and the left rotor 103j with a sealed low pressure chamber 155j′ to store Lox, two thermal jet engines 100j can be equipped with two generators to be a twin rotor gas turbines, it not only solve the heat issue with two fans, not only use two streams and heat exchangers to cool down the turbine temperate as four stages and use up and recycle all heat at the last stage at the center, other key takeaway is the super low noise level, because the pair of the rotors with the highest efficiency over all existing gas turbines, two thermal jet engines 100j can be made as a twin rotor high pressure compressor with electrical motors, it can produce more power compression gas than any type of compressors in the world without conventional shaft couple and side loads, a pair of income gases streams are repowered with a high centrifugal blades and low blades at the middle section with the combination of axial blades and centrifugal blades in the all process, the compressor would be so quiet that you never see before or notice, because all waste energy in the conventional compressors as forms of heat or noise, vibration is either be recycled or cancel out with the twin rotor design and multiple stages and method approaches.

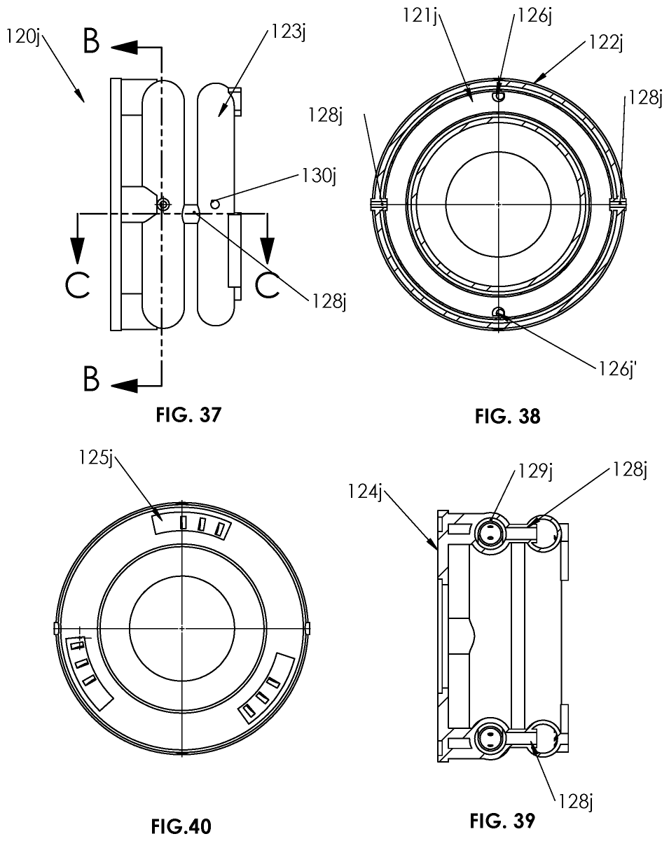

Referring FIGS. 37-40, the burner 120j has a mixed torus tubing 121j, torus combustion tubing 122j with multiple holes 129j and a conditioning tubing 123j, a front fixed air intake plate 124j and three back injector plates 125j, the fixed front air intake plate 124j delivery the air in the high pressure chamber into the a mixed torus tubing 121j along with fuel through tubing 126j, 126j′, through a burner tubes 128j into the conditioning tubing 123j with holes 127j for adding additional air or water to control the temperature or mass of outgoing fluid, the burner 120j′ has the similar structure.

Although the description above contains many specifications, these should not be construed as limiting the scope of the invention but as merely providing illustration of some of the presently preferred embodiments of this invention. Thus, the scope of the invention should be determined by the appended claims and their legal equivalents, rather than by the examples given.

### Conclusion and Impact

First, the shaft less twin rotor turbomachine has the highest power density and efficiency over the conventional turbomachines, if we use the same length and the diameter to design both the conventional turbomachine and this turbomachine, this turbomachine is a clear winner, because the conventional turbomachine is an area base machine, this turbomachine is a volume base machine, so it produces more power, it pass the Betz limit as a power producer, while as a power receiver, it can use up 75 to 95% input power without negative effect, this turbomachine can use up 85% of the converting power, because there is no flow blockage issue at the center lower zone regardless the speed of rotor or number of blades, the peak performance would be obtained in a much easy way with a pair of clockwise rotary gas stream and an anticlockwise rotary gas stream and with the high pressure in the high power zone and high flow rate at the low power zone, this turbomachine fully uses up the total volume from the center thrust bore at low power and high power zone (out power/total turbomachine volume=power density) Second this turbomachine has revolved the fundamental problems the conventional turbomachine faced with and even surpass in all, as the following;
(a) Shaft less design, it profoundly change the history of turbomachinery, from drivetrain to blade designs. First the shaft less design open up the center passage to the top limit and replace the shaft with tubing rotor, second according to the Machinery's Handbook 27th Edition at page 307 Example: A 4-inch shaft, with a 2-inch hole through it, has a weight 25 percent less than a solid 4-inch shaft, but its strength is decreased only 6.25 percent.
(b) Thermal efficiency, for jet engine as an application of the turbomachine, it would be thermodynamically optimized mechanism divides the conventional one cycle into the multiple thermal cycles, includes the high thermal cycle with rotary and thrust output, a middle thermal cycle with rotary and thrust output, and low thermal cycle with thrust output only along with the water cooling device, an energy equalizer, the maximum combination number would be 3×2×1=6, just like a car transmission or conventional multiple spool compressor, the difference is that the thermal engine uses thermal mechanism to generate more power, the rest of the jet engines multiple mechanisms to reduce power, the thermal mechanism is more reliable and efficient, because the heat is transferrable between two thermal systems, while heat in the transmission or the multiple spool compressor cannot be transferred back to the engine, the combination of multiple thermal cycles is so powerful that it can maneuver an aircraft to surpass all current military aircraft capability and make gas turbine or compressor so quiet you never see before!!!, for example as the data shows that the most noise of jet engine comes from the compressor, the burner and the turbine in an order, so in clandestine operations, only the central thrust cycle can operate to minimize the noise without compressor and turbine operation, while for flight jet or air turbulent, high pressure air from high pressure chamber can be redirected to the central thrust bore, since there is no rotary movement, the thrust is much greater with less fuel or in case of low fuel. In addition, the fuel selection is another variable to maneuver the movement, and includes the kerosene, alcohol and hot water to change speed movement by changing the temperature or the intensity of chemical reaction, for the burner on the rocket engine, the modulation of combustion is used for the first time with high thermal efficiency, for the jet engine the entry torus tube receives the compressed hot air then enters the pre conditioning torus tube mixed with fuel and expands, because the entry torus tube is interconnected with pre conditioning torus tube, so the compressed hot air has heat exchange with the pre conditioning torus tube, then goes to the combustion tube with a tap sharp and one layer, expand again, the fuel would never stay on one location rather evenly distribute to each combustion tube, so the hot gas would never go back, then enters the post conditioning container, and expands again and equalize all hot gas to inject into the blades, for rocket engine, the entry torus tube receives Lox and expands, then enters pre conditioning torus for gasification, then enters the combustion tube with a tap sharp with multiple layers, combust with TEA-TEB or fuel, there is heat exchange but one fluid exchange, the hot gas would never go back, because the hot gas expand to the least resistant volume not through multiple layers to the pre conditioning tube, then enter to the post-conditioning container, so multiple concentric burners or cover can be added for high thermal efficiency and safety, which is much lighter, more efficient and safer than the gas generator, the shaft less twin rotor gas turbines and the shaft less twin rotor compressor are other examples with the highest mechanical and thermal efficiency over all existing peer products, the shaft less twin rotor compressor can produce two different compression gases, low pressure gas and high pressure gas, also the chamber front of the high pressure chamber can be connected to the low pressure storage, so the twin rotor compressor become 6 or 8 stage compressor to produce even higher pressures in a very small volume.
(c) Sealability, the seal ring assembly is another achievement, with no existing solution performing not even closed, the robust seal ring assembly is based on the centrifugal mechanism, surface tension, and fluid dynamics, it provides both static seals as well as dynamic seals, for the static seals, when the two V seal rings are fully engaged, there is no fluid to pass through between the V seal rings. For the dynamic seals, as the rotation speed up, there are three factors, centrifugal force, tangential speed, rotational speed with the V seal surface, since there is a little mass of fluid in the engagement surface to move the fluid up, while the tangential speed of the dynamical V seal ring can only carry the fluid around along the conical surface of V seal ring, but since there is no axial force or pressure difference along the V ring seal surfaces, there is no leak, finally in order to move the fluid forward, the solid gap must be established at high speed, because of the surface tension, even little fluid may pass between the V seal rings, the fluid in the pressure equalized slot would hold the little fugitive fluid, it would play a key role in rocket engine turbo-pump.
(d) The reliability is a paramount requirement for all turbomachine, the reliability improvement for the turbomachine include two levels, the system level as well as the component level, at the system level, like the jet engine, the thermal cycles greatly increase reliability with three redundancies, if one fails the other two can still work, especially the central thrust which works without compressor and turbine, other is the single moving like the rotor assembly which greatly increase reliability far more than other measure, at the component level, the rotor blades are no longer the weakest link, the universal bearing are greatly improved in term of load, stress and heat dissipation, like the twin centrifugal turbo pump has the highest reliability.
(e) The universal bearing provides a long sought solution, it not only support radial as well as axial loads but also it is tolerable with clearance due to wedge insert ring, it can seal off and be self-lubricated, more importantly it resolves the inherent problem with small bearing to support large rotor, now because the shaft is replaced by the tubing rotor, so the large bearing has more contact areas, more balls to support the load, so it can sustain high speed under cryogenic or high temperature and be easily installed and replaced under a designed period, the left ring and right can be made out of magnetic material and the assembly become much easier.
(f) The new blade design is a paradigm shift, it changes the blade design order from root-tip to tip-root, as we can see the rotor external blades is no longer the weakest link and rather become more reliable and stronger in the jet engine application or wind turbines, sine the highest torque point is at the largest diameter at the tip, the tip is logically reinforced with the edge rings, as the change with the tubing rotor, the diameter of the blade increase accordingly, since they are wheel based design, as the diameter of the turbomachine increases, the more wheel base modules would be added without redesign of the blade, the most important change is the blade design based on the rotation and torsion not on airplane wind drag and lift, the foundational question for pump designs is based on rpm with centrifugal pump, or on hybrid design with torsion, the centrifugal pump has low efficiency, because the rotary speed of flow is less than the rotary speed of rotor, in most cases, the weight of a fluid in volute is less than that of the rotor of the centrifugal pump, so more than 50% rotary energy is a waste on the rotor not on the flow, so if the centrifugal pump takes 60% of input power like a gas turbine or electrical motor, as a result, only 30% of total input power is used to power the fluid, while the hybrid pump in this invention can take 80 to 95% input power, the rotors here is based on an optimized combination of the rotary speed and torsion of the blades to maximize output flow power with the two power zone with up to 85%, just think about the rocket turbo pump, if the capacity stays the same, the propellant would reduce at 20 to 30% on the pre burners or gas generators.
(g) Cost reduction, because of single moving part design, it greatly reduces the cost of production and assembly, the big cost reduction is contributed to the new blade design, furthermore, the joint method is with two spring pin or coiled pins to secure the edge ring between each modular to replace the complicated root joint design, moreover, other cost reduction is that the three thermal cycle system replace a single thermal cycle system with the multiple spool compressor, finally the burner become simpler and more efficient, these improvements greatly reduce the purchasing cost as well as operation cost, for purchasing cost of the conventional jet engine, most of cost related to the complicated multiple spool compressor, rotor blades joint and burner, shaft, as well as overkilled materials, they are eliminated, so material weights and production time are reduced as well, as far as the operation cost is concerned, if overweigh of engine adding to aircraft.
(h) Maneuverability is a good start of a next generation of turbomachine, it not only increase maneuverability like hybrid gas power and electrical power, independent operation for left rotor and right rotor, three marine propellers for submarine
(i) Scalability with the component modulation like fixed wheels and rotary wheels, combination of the left rotor, right rotor and the union, the Scalability greatly increase, as a result, it not only reduce the cost, but also increase the reliability and the production capability to meet various customers in a short delivery time.
(j) Beyond the limit, this invention bring a disrupt invocation in many grounds from universal ball bearing, high speed seal ring assembly, as well as the simple burner, jet engine, turbo pump, marine propeller, the new ramjet engine, efficiency and reliability on and on, because human has insatiable desire to break their limit, as the history shows us the invention of car to break our leg limit, the invention of telescope to break our eye limit, to invent the fountain. of youth is to break our life span limit, what is the next thing to break our limits or what is next thing to break the limits for wind turbine, wave turbine or tidal turbine? Stay tuned.

I claim:

1. A turbomachine system has at least one turbomachine, the at least one turbomachine has a body assembly, a twin tubing rotor assembly movably disposed in said body assembly by means of at least two ball bearings disposed between said twin tubing rotor assembly and said body assembly for providing dynamic supports, and by means of at least two seal assemblies disposed between said twin tubing rotor assembly and said body assembly for providing seals, said body assembly has a left body assembly having at least one fixed wheel and a body bore and a right body assembly having at least one fixed wheel and a body bore, said left body assembly has one of plurality of structures including one piece structure and two-piece structure, said right body assembly has one of plurality of structures including one piece structure and two-piece structure, said twin tubing rotor assembly has a left rotor having a tubing housing having at least one internal rotary wheel and at least one external rotary wheel and a tubing bore, a right rotor having a tubing housing having at least one internal rotary wheel and at least one external rotary wheel and a tubing bore, and a union to support said left rotor and said right rotor, said union has one of plurality of supporting methods including (1) two static supports (2) two dynamic supports (3) one static support and one dynamic support (4) at least one hybrid support, said static support is defined by one of plurality of methods including welding, press fitting and gluing, said dynamic support is defined by one of the at least two ball bearings disposed between said union and one of said left rotor and said right rotor, the at least one hybrid support is defined by a magnetic coupling, each of the at least two ball bearings has a left ring and a right ring and multiple balls disposed between said left ring and said right ring, a left, wedge insert ring and a right wedge insert ring respectively disposed between said left ring and said right ring, said left ring has a left conical surface and a left ball groove, said right ring has a right conical surface and a right ball groove, said multiple balls are respectively engaged with said left ball groove and said right ball groove, said left insert ring and said right insert ring are respectively disposed between said left conical surface and said right conical surface, said left ring and said right ring have one of plurality of materials including magnetic materials and nonmagnetic materials the at least two ball bearings has fluids for providing seals, each of the at least two seal ring assemblies disposed between said tubing bore and said body bore with press fits has at least one fixed V shape seal ring having a conical surface and at least one dynamic V seal ring having a mated conical surface engaged with said conical surface of the at least one fixed V shape seal ring in one of plurality methods including an axial method and a radial method for providing dynamic as well as static seals, said each of the at least two seal ring assemblies has a top gap defined by said body bore and the at least one dynamic V shape seal ring, and a low gap defined by said tubing bore and the at least one fixed V shape seal ring, said each of the at least two seal ring assemblies has at least one groove between the at least one fixed V shape seal ring and the at least one dynamic V shape seal ring said turbomachine system has one of plurality of power supplies including (a) internal gas powers (b) internal electrical powers (c) internal gas powers and internal electrical powers (d) external gas powers external electrical powers (f) external gas powers and internal electrical powers (g) external powers (h) internal powers.

2. The turbomachine system of claim 1, wherein said body assembly having a main port defined by an inlet port, an outlet port, said left body assembly has a left rotor bore receiving said left rotor to form a first left rotor chamber, and a second left rotor chamber connected with a relief hole, said right assembly has a right rotor bore receiving said right rotor to form a first right rotor chamber, and a second right rotor chamber connected to a relief hole, said left body assembly has a first of the at least one fixed wheel having gas injectors extending to an inlet hole, a second of the at least one fixed wheel having multiple blades and a relief hole, said right body assembly has a first of the at least one fixed wheel having gas injectors extending to an inlet hole, a second of the at least one fixed wheel having multiple blades and a relief hole, said left rotor has a first of the at least one internal rotary wheel having multiple blades with an inside diameter dividing said main port into a high power zone and a lower power between said inlet port and said outlet port, and a first of the at least one external rotary wheel having blades disposed in said first left rotor chamber and at least one left set of holes communicating between said main port and said first left rotor chamber, a second of the at least one external rotary wheel having multiple blades and a third of the at least one external rotary wheel having multiple blades disposed in said second left rotor chamber sandwiching said second of the at least one fixed wheel having multiple blades, said right rotor has a first of the at least one internal rotary wheel having multiple blades a first of the at least one external rotary wheel having blades disposed in said first right rotor chamber and at least one right set of holes communicating between said main port and said first right rotor chamber, a second of the at least one external rotary wheel having multiple blades and a third of the at least one external rotary wheel having multiple blades disposed in said second right rotor chamber sandwiching said second of the at least one fixed wheel having multiple blades, said union has an internal rotary wheel having multiple blades and one of plurality of hole forms including multiple axial non-through holes and multiple axial through holes between said left rotor and said right rotor.

3. The turbomachine system of claim 1, wherein said body assembly having a main port defined by an inlet port, an outlet port and an left electrical device having a left electrical stator and a left electrical rotor and a right electrical device having a right electrical stator and a right electrical rotor, said left body assembly has a left rotor bore receiving said left rotor to form a first left rotor chamber and a second left rotor chamber, said right assembly has a right rotor bore receiving said right rotor to form a first right rotor chamber and a second right rotor chamber, said left body assembly has a first of the at least one fixed wheel having said left electrical stator in said second left rotor chamber, said left rotor has a first of the at least one internal rotary wheel having blades with an inside diameter dividing said main port into a high power zone and a lower power between said inlet port and said outlet port, and a first of the at least one external rotary wheel having blades disposed in said first left rotor chamber and at least one left set of holes communicating between said main port and said first left rotor chamber, a second of the at least one external rotary wheel having said left electrical rotor engaged with said left electrical stator in said second right rotor chamber, said right body assembly has a first of the at least one fixed wheel having said right electrical stator in said second tight rotor chamber, said right rotor has a first of the at least one internal rotary wheel having blades and a first of the at least one external rotary wheel having blades disposed in said first right rotor chamber and at least one right set of holes communicating between said main port and said first right rotor chamber, a second of the at least one external rotary wheel having said right electrical rotor engaged with said right electrical stator in said second right rotor chamber, said union has an internal rotary wheel having blades and one of plurality of holes forms including multiple axial non-through holes and multiple axial through holes between said left rotor and said right rotor.

4. The turbomachine system of claim 1, wherein said body assembly having a main port defined by an inlet port, an outlet port and a right electrical device having a right stator and a right electrical rotor and a relief hole said left body assembly has a left rotor bore receiving said left rotor to form a first left rotor chamber and a second left rotor chamber connected with said relief hole, said right body assembly has a right rotor bore receiving said right rotor to form a first right rotor chamber and a second right rotor chamber, said union has an external wall having one of the at least two seal assemblies between said second left rotor chamber and said second right rotor chamber, said left body assembly has a first of the at least one fixed wheel having gas injectors extending to an inlet hole, a second of the at least one fixed wheel having multiple blades, said left rotor has a first of the at least one internal rotary wheel having blades with an inside diameter dividing said main port into a high power zone and a lower power between said inlet port and said outlet port, and a first of the at least one external rotary wheel having blades disposed in said first left rotor chamber and at least one left set of first set of holes communicating between said main port and said first left rotor chamber, a second of the at least one external rotary wheel having blades and a third of the at least one external rotary wheel having blades disposed in said second left rotor chamber sandwiching said second one of the at least one fixed wheel having multiple blades, said right body assembly has a first of the at least one fixed wheel having said right electrical stator, a first of the at least one internal rotary wheel having blades and a first of the at least one external rotary wheel having blades disposed in said first right rotor chamber and at least one right set of holes communicating between said main port and said first right rotor chamber, a second of the at least one external rotary wheel having said right electrical rotor engaged with said right electrical stator in said second right rotor chamber, said union has an internal rotary wheel having blades and one of plurality of holes forms including multiple axial non-through holes and multiple axial through holes between said left rotor and said right rotor.

5. The turbomachine system of claim 1, wherein said body assembly having a main port defined by an inlet port, an function port defined by one of plurality of functions including inlet functions and outlet functions, a relief hole and a left electrical device having a left electrical stator and a left electrical rotor and a right electrical device having a right electrical stator and a right electrical rotor, said union has one of plurality of structures including no-internal wall and an internal wall having a left set of blades and a right set of blades, said left body assembly has a left rotor bore receiving said left rotor to form a first left rotor chamber and a second left rotor chamber and a third left rotor camber, said right body assembly has a right rotor bore receiving said right rotor to form a first right rotor chamber a second right rotor chamber, and a third right rotor camber, said left body assembly has a first of the at least one fixed wheel having said left electrical stator, a second of the at least one fixed wheel having multiple left through holes, said left rotor has a first of the at least one internal rotary wheel having blades with an inside diameter dividing said main port into a high power zone and a lower power, and a first of the at least one external rotary wheel having said left electrical rotor engaged with said left electrical stator in said first left rotor chamber, a second of the at least one external rotary wheel having blades in said second left rotor chamber and at least one left set of holes between said main port and said second left rotor chamber, a third of the at least one external rotary wheel having blades disposed in said third left rotor chamber engaged with said right rotor, said right body assembly has a first of the at least one fixed wheel having said right electrical stator, a second of the at least one fixed wheel having multiple right through holes, said right rotor has a first of the at least one internal rotary wheel having blades dividing said main port into a high power zone and a lower power and a first of the at least one external rotary wheel having said right electrical rotor engaged with said right electrical stator in said first left rotor chamber, a second of the at least one external rotary wheel having blades disposed in said second right rotor chamber, and at least one right set of holes communicating between said main port and said second right rotor chamber, a third of the at least one external rotary wheel having multiple blades disposed in said third right rotor chamber engaged with said left rotor.

6. The turbomachine system of claim 3, said union has one of plurality of structures connected to said external power supplies including (a) gear train power supplies (b) belt/wheel powers supplies.

7. The turbomachine system of claim 1, said body assembly has a main port defined by a left inlet port and a right inlet port, at least one outlet port and a left electrical device having a left electrical stator and a left electrical rotor and a right electrical device having a right electrical stator and a right electrical rotor, said left body assembly has a left rotor bore receiving said left rotor to form an external left rotor chamber, an internal left rotor chamber having multiple relief holes extending to the at least one outlet port and a first left rotor chamber, said right assembly has a right rotor bore receiving said right rotor to form an external right rotor chamber and an internal right rotor chamber having multiple relief holes extending to the at least one outlet port and a first right rotor chamber, said left, body assembly has a first the at least one fixed wheel having said left electrical stator, a second of the at least one fixed wheel having external gas injectors extending to said left inlet port, a third of the at least one fixed wheel having external multiple blades, a first the at least one fixed wheel having internal gas injectors extending to said left, inlet port, a second of the at least one fixed wheel having internal multiple blades, said left rotor has a first of the at least one internal rotary wheel having blades and a second of the at least one internal rotary wheel having blades sandwiching said second of the at least one fixed wheel having internal multiple blades in said internal left rotor chamber, a first of the at least one external rotary wheel having said left electrical rotor engaged with said electrical stator in said first left rotor chamber, a second of the at least one external rotary wheel having blades and a third of the at least one external rotary wheel having blades sandwiching said second of the at least one fixed wheel having external multiple blades in said external left rotor chamber, said right body assembly has a first the at least one fixed wheel having said right electrical stator, a second of the at least one fixed wheel having external gas injectors extending to said right inlet port, a third of the at least one fixed wheel having external multiple blades, a first the at least one fixed wheel having internal gas injectors extending to said right inlet port, a second of the at least one fixed wheel having internal multiple blades, said right rotor has a first of the at least one internal rotary wheel having blades and a second of the at least one internal rotary wheel having blades sandwiching said second of the at least one fixed wheel having internal multiple blades in said internal right rotor chamber a first of the at least one external rotary wheel having said right electrical rotor engaged with said right electrical stator in said first right rotor chamber, a second of the at least one external rotary wheel having blades and a third of the at least one external rotary wheel having blades sandwiching said second of the at least one fixed wheel having external multiple blades in said external right rotor chamber.

8. The turbomachine system of claim 1, wherein said body assembly has a main port defined by an inlet port, an outlet port, a left relief ring and a right relief ring, at least one joint control shaft having multiple through holes, said left body assembly has a left extension, a left rotor bore receiving said left rotor to form a first left rotor chamber and a second left rotor chamber, said right body assembly has a right extension, a right rotor bore receiving said right rotor to form a first right rotor chamber and a second right rotor chamber, said left body assembly has a first of the at least one fixed wheel having gas injectors extending to an inlet hole, a second of the at least one fixed wheel having multiple blades and a relief hole in said second left rotor chamber said left rotor has a first of the at least one internal rotary wheel having blades with an inside diameter dividing said main port into a high power zone and a lower power between said inlet port and said outlet port, and a first of the at least one external rotary wheel having blades disposed in said first left rotor chamber and at least one left set holes communicating between said main port and said first left rotor chamber, a second of the at least one external rotary wheel having blades and a third of the at least one external rotary wheel having blades disposed in said second left rotor chamber sandwiching said second one of the at least one fixed wheel having multiple blades, said left extension has an external surface and an internal surface and multiple cross holes between said external surface and said internal surface, said left body assembly also has multiple holes between said first left rotor chamber and said left extension, said right body assembly has a first of the at least one fixed wheel having gas injectors extending to an inlet hole, a second of the at least one fixed wheel having multiple blades and a relief hole in said second right rotor chamber, said right rotor has a first of the at least one internal rotary wheel having blades a first of the at least one external rotary wheel having blades disposed in said first right rotor chamber and at least one right set of holes communicating between said main port and said first right rotor chamber, a second of the at least one external rotary wheel having blades and a third of the at least one external rotary wheel having blades disposed in said second right rotor chamber sandwiching said second of the at least one fixed wheel multiple blades, said right extension has an external surface and an internal surface and multiple cross holes between said external surface and said internal surface, said right body assembly also has multiple holes between said first right rotor chamber and said right extension, said union has an internal rotary wheel having blades and one of plurality of holes forms including multiple axial non-through holes and multiple axial through holes between said left rotor and said right rotor.

9. The turbomachine system of claim 1, wherein said body assembly has a main port defined by an inlet port, an outlet port, two relief rings and at least one joint control shaft having multiple through holes, and a left electrical device having a left stator and a left electrical rotor and a right electrical device having a right stator and a right electrical rotor, said left body assembly has a left extension, a left rotor bore receiving said left rotor to form a first left rotor chamber and a second left rotor chamber, said right assembly has a right extension, a right rotor bore receiving said right rotor to form a first right rotor chamber and a second right rotor chamber, said left body assembly has a first of the at least one fixed wheel having said left electrical stator in said second left rotor chamber said left rotor has a first of the at least one internal rotary wheel having blades with an inside diameter dividing said main port into a high power zone and a lower power between said inlet port and said outlet port and a first of the at least one external rotary wheel having blades disposed in said first left rotor chamber and at least one left set of holes communicating between said main port and said first left rotor chamber, and a second of the at least one external rotary wheel having said left electrical rotor engaged with said left electrical stator in said second left rotor chamber, said right body assembly has a first of the at least one fixed wheel having said right electrical stator, said right rotor has a first of the at least one internal rotary wheel having blades and a first of the at least one external rotary wheel having blades disposed in said first right rotor chamber and at least one right set of holes communicating between said main port and said first right rotor chamber, a second of the at least one external rota wheel having said right electrical rotor engaged with said right electrical stator said second right rotor chamber, said left extension has an external surface and an internal surface and multiple cross holes between said external surface and said internal surface, said left body assembly also has multiple holes between said first left rotor chamber and said left extension, said right extension has an external surface and an internal surface and multiple cross holes between said external surface and said internal surface, said right body assembly also has multiple holes between said first right rotor chamber and said right extension, said union has an internal rotary wheel having blades and one of plurality of multiple of holes forms including multiple axial non-through holes and multiple axial through holes between said left rotor and said right rotor.

10. The turbomachine system of claim 2, wherein said body assembly has a main port defined by an inlet port, an outlet port, at least one control shaft having multiple through holes and a right electrical device having a right electrical stator and a right electrical rotor said union has an external wall said left body assembly has a left extension, a left rotor bore receiving said left rotor to form a first left rotor chamber and a second left rotor chamber, said right body assembly has a right extension, a right rotor bore receiving said right rotor to form a first right rotor chamber and a second right rotor chamber, said left body assembly has a first of the at least one fixed wheel having gas injectors extending to an inlet hole, a second of the at least one fixed wheel multiple blades and a relief hole in said second left rotor chamber, said left rotor has a first of the at least one internal rotary wheel having blades with an inside diameter dividing said main port into a high power zone and a lower power between said inlet port and said outlet port, and a first of the at least one external rotary wheel having blades disposed in said first left rotor chamber and at least one left, set of holes communicating between said main port and said first left rotor chamber, a second of the at least one external rotary wheel having blades and a third of the at least one external rotary wheel having blades disposed in said second left rotor chamber sandwiching said second of the at least one fixed wheel having multiple blades, said left extension has an external surface and an internal surface and multiple cross holes between said external surface and said internal surface, said left body assembly also has multiple holes between said first left rotor chamber and said left extension, said right body assembly has a first of the at least one fixed wheel having said right electrical stator, said right rotor has a first of the at least one internal rotary wheel having blades and a first of the at least one external rotary wheel having blades disposed in said first right rotor chamber and at least one right set of holes communicating between said main port and said first right rotor chamber, a second of the at least one external rotary wheel having said right electrical rotor engaged with said right electrical stator in said second right rotor chamber, said right extension has an external surface and an internal surface and multiple cross holes between said external surface and said internal surface, said right body assembly also has multiple holes between said first right rotor chamber and said right extension, said union has an internal rotary wheel having blades and one of plurality of holes forms including multiple axial non-through holes and multiple axial through holes between said left rotor and said right rotor.

11. The turbomachine system of claim 2, wherein said body assembly has a main port defined by an inlet port, an outlet port, at least one control shaft having multiple through holes and a left electrical device having a left stator and a left electrical rotor and a right electrical device having a right stator and a right electrical rotor, said left body assembly has a left extension, a left rotor bore receiving said left rotor to form a first left rotor chamber and a second left rotor chamber and a third left rotor chamber, said right body assembly has a right extension a right rotor bore receiving said right rotor to form a first tight rotor chamber and a second right rotor chamber and a third right rotor chamber, said left body assembly has a first of the at least one fixed wheel having said left electrical stator, a second of the at least one fixed wheel multiple through holes, said left rotor has a first of the at least one internal rotary wheel having blades with an inside diameter dividing said main port into a high power zone and a lower power between said inlet port and said outlet port, a first of the at least one external rotary wheel having said left electrical rotor engaged with said left electrical stator in said first left rotor chamber, and a second of the at least one external rotary wheel having blades disposed in said second left rotor chamber and at least left one set of holes communicating between said main port and said second left rotor chamber, a third of the at least one external rotary wheel having blades disposed in said third left rotor chamber engaged with said right rotor, said left extension has an external surface and an internal surface and multiple cross holes between said external surface and said internal surface, said left body assembly also has multiple holes between said first second rotor chamber and said left extension, said right body assembly has a first of the at least one fixed wheel having said right electrical stator and a second of the at least one fixed wheel multiple through holes, said right rotor has a first of the at least one internal rotary wheel having blades and a first of the at least one external rotary wheel having said right electrical rotor engaged with said right electrical stator in said first right rotor chamber a second of the at least one external rotary wheel having blades disposed in said second right rotor chamber and at least one right set of holes communicating between said main port and said second right rotor chamber, a third of the at least one external rotary wheel having blades disposed in said third right rotor chamber engaged with said left rotor, said right extension has an external surface and an internal surface and multiple cross holes between said external surface and said internal surface, said right body assembly also has multiple holes between said second right rotor chamber and said right extension, said union has an internal rotary wheel having blades and one of plurality of holes forms including multiple axial non-through holes and multiple axial through holes between said left rotor and said right rotor.

12. The turbomachine system of claim 9, where said turbomachine system has one of plurality of installing methods in marine vehicles defined by a front head and a back tail and a left side and right side including (1) the at least one turbomachine installed in said back tail of said marine vehicles (2) the at least one installed in said left side of said marine vehicles and the at least one installed in said right side of said marine vehicles (3) the at least one installed in said left side of said marine vehicles and the at least one installed in said right side of said marine vehicles and the at least one turbomachine installed in said back tail of said marine vehicles.

13. The turbomachine system of claim 1, wherein said body assembly has a left main port defined by a left inlet port and a left outlet port and a right main port defined by a right inlet port and a right outlet port, said union has one of plurality of structures including an (1) internal wall having a fight set of blades and a left set of blades (2) no internal wall, said left body assembly has a left rotor bore receiving said left rotor to form a first left rotor chamber and a second left rotor chamber having a relief hole, said right assembly has a right rotor bore receiving said right rotor to form a first right rotor chamber and a second right rotor chamber having a relief hole, said left body assembly has a first of the at least one fixed wheel having gas injectors extending to an inlet hole, a second of the at least one fixed wheel having multiple blades, a left volute groove between the left outlet port and said first rotor chambers connected with said left inlet port said left rotor has a first of the at least one internal rotary wheel having blades defined by a combination of backward centrifugal blades and axial blades having an inside diameter dividing said main left main port into a high power zone and a low power zone, a second of the at least one internal rotary wheel having centrifugal blades engaged with said left volute groove and an opening, and an internal groove between said first of the at least one internal rotary wheel, and multiple through holes between said opening and said internal groove, said left rotor also has a first of the at least one external rotary wheel having blades and a second of the at least one external rotary wheel having blades disposed in said second left rotor chamber sandwiching said second of the at least one fixed wheel having multiple blades, said right body assembly has a first of the at least one fixed wheel having gas injectors extending to an inlet hole, a second of the at least one fixed wheel having multiple blades, a right volute groove between said right outlet port and said first right rotor chamber connected with said right inlet port, said right rotor has a first of the at least one internal rotary wheel having blades defined by a combination of backward centrifugal blades and axial blades having an inside diameter dividing said right main port into a high power zone and a low power zone, a second of the at least one internal rotary wheel having centrifugal blades engaged with said right volute groove and an opening and an internal groove between said first of the at least one internal rotary wheel and multiple through holes between said opening and said internal groove said right rotor also has a first of the at least one external rotary wheel having axial blades and a second of the at least one external rotary wheel having blades disposed in said second right rotor chamber sandwiching said second of the at least one fixed wheel having multiple blades.

14. The turbomachine system of claim 1, wherein said body assembly has a left main port defined by a left inlet port and a left outlet port and a right main port defined by a right inlet port and a right outlet port and a fight electrical device having a right electrical stator and a right electrical rotor, said union has one of plurality of structures including (1) an internal wall having a left set of blades and a right set of blades an external wall and (2) an external wall, said left body assembly has a left rotor bore receiving said left rotor to form a first left rotor chamber and a second left rotor chamber expanding to a relief hole said right assembly has a right rotor bore receiving said right rotor to form a first right rotor chamber and second right rotor chamber, said left body assembly has a first of the at least one fixed wheel having gas injectors extending to an inlet hole, a second of the at least one fixed wheel having multiple blades, a left volute groove between the left outlet port and said first left rotor chamber connected with said left inlet port, said left rotor has a first of the at least one internal rotary wheel having blades defined by a combination of backward centrifugal blades and axial blades having an inside diameter dividing said main left main port into a high power zone and a low power zone, a second of the at least one internal rotary wheel having centrifugal blades engaged with said left volute groove and an opening and an internal groove between said first of the at least one internal rotary wheel and said internal wall and multiple through holes between said opening and said internal groove, said left rotor also has a first of the at least one external rotary wheel having axial blades and a second of the at least one external rotary wheel having blades disposed in said second right rotor chamber sandwiching said second of the at least one fixed wheel having multiple blades, said right body assembly has a first of the at least one fixed wheel having said right electrical stator, a right volute groove between said right outlet port and said first right rotor chamber, said right rotor has a first of the at least one internal rotary wheel having blades defined by a combination of backward centrifugal blades and axial blades having an inside diameter dividing said main right main port into a high power zone and a low power zone, a second of the at least one internal rotary wheel having centrifugal blades engaged with said right volute groove, and an opening and an internal groove between said first of the at least one internal rotary wheel and said internal wall, and multiple through holes between said opening and said internal groove, said right rotor also has a first of the at least one internal rotary wheel having said right electrical rotor engaged with said right electrical stator in said second right rotor chamber.

15. The turbomachine system of claim 1, said union has an internal rotary wheel having blades with an inside diameter to form a high power zone and a low power zone, a front support having at least two link bars and a shaft adapter connected to said external powers.

16. The turbomachine system of claim 1, wherein said body assembly has a main port defined by an inlet port and an outlet port, a heat exchanger, said union has an internal rotary wheel having multiple blades, said left body assembly has a left rotor bore receiving said left rotor to form a first left rotor chamber and a second left rotor chamber, said right body assembly has a right rotor bore receiving said right rotor to form a first right rotor chamber and a second right rotor chamber, said left body assembly has a front extension having a fan bore, a first of the at least one fixed wheel having multiple blades with a first segment ring, a second of the at least one fixed wheel having blades with a second segment ring, a third of the at least one fixed wheel having a top pressure storage and a low pressure storage, said first left rotor chamber is defined by a top pressure chamber connected with said top pressure storage and a low pressure chamber connected with said low pressure storage, said left rotor has a first of the at least one internal rotary wheel having blades with an inside diameter dividing said main port into a high power zone and a low power zone, and a first of the at least one external rotary wheel having blades disposed in said fan bore, and at least one set of holes communicating between said main port and said low pressure chamber, said left rotor also has a second of the at least one external rotary wheel having blades with a second edge ring and a second segment ring, a third of the at least one external rotary wheel having blades with an third edge ring and a third segment ring, a fourth of the at least one external rotary wheel having blades with a fourth edge ring and a fourth segment ring, said edge rings have one of plurality structures including one piece structure and multiple pieces structure, said right body assembly has a top burner extending to said top pressure storage and a low burner extending to said low pressure storage and a first of the at least one fixed wheel having at least one set of blades, said right rotor has a first of the at least one internal rotary wheel having blades, a first of the at least one external rotary wheel having at least one set of blades and second of the at least one external rotary wheel having at least one set of blades disposed in said second right rotor chamber respectively sandwiching said first of the at least one fixed wheel having the at least one set of blades, said right body assembly has a back burner having a umbrella cover with multiple through holes and multiple internal fuel injectors and internal multiple igniters as well as multiple external fuel injectors and external multiple igniters in said first right rotor chamber, said umbrella cover is constructed with one of plurality of methods including with said right rotor and with said right body assembly, said heat exchanger is connected to said low burner.

17. The turbomachine system of claim 1, wherein said body assembly has a main port defined by an inlet port and an outlet port, a heat exchanger and an electrical device having an electrical stator and an electrical rotor, said union has an internal rotary wheel having multiple blades and an external wall, said left body assembly has a left rotor bore receiving said left rotor to form a first left rotor chamber and a second left rotor chamber with said external wall, said right body assembly has a right rotor bore receiving said right rotor to form a first right rotor chamber and a second right rotor chamber, said left body assembly has a front extension having a fan bore a first of the at least one fixed wheel having multiple blades with a first segment ring, a second of the at least one fixed wheel having blades with a second segment ring, a third of the at least one fixed wheel having a top pressure storage and a low pressure storage, said first left rotor chamber is defined by a top pressure chamber connected with said top pressure storage and a low pressure chamber connected with said low pressure storage, said right body assembly has a top burner extending to said top pressure storage and a low burner extending to said low pressure storage and a first of the at least one fixed wheel having at least one set of blades said left rotor has a first of the at least one internal rotary wheel having blades with an inside diameter dividing said main port into a high power zone and a low power zone, and a first of the at least one external rotary wheel having blades disposed in said fan bore, and at least one set of holes communicating between said main port and said low pressure chamber said left, rotor also has a second of the at least one external rotary wheel having blades with a second edge ring and a second segment ring, a third of the at least one external rotary wheel having blades with an third edge ring and a third segment ring, a fourth of the at least one external rotary wheel having blades with a fourth edge ring and a fourth segment ring, a fifth of the at least one external rotary wheel having said electrical rotor engaged with said electrical stator in said second left rotor chamber, said right rotor has a first of the at least one internal rotary wheel having blades, a first of the at least one external rotary wheel having at least one set of blades disposed in said second right rotor chamber respectively engaged with said first of the at least one fixed wheel having the at least one set of blades, said right body assembly has a back burner having a umbrella cover with multiple through holes and multiple internal fuel injectors and internal multiple igniters as well as multiple external fuel injectors and external multiple igniters in said first right rotor chamber said umbrella cover is constructed with one of plurality of methods including with said right rotor and with said right body assembly, said heat exchanger is connected to said low burner.

18. The turbomachine system of claim 1, wherein said body assembly has a left electrical device having a left stator and a left electrical rotor and a right electrical device having a right stator and a right electrical rotor, at least two heat exchangers, said union has one of plurality structures including with an internal wall having a left set of blades and a right set of blades and without an internal wall, said left body assembly has a left rotor bore receiving said left rotor to form a first left rotor chamber and a second left rotor chamber and a third left rotor chamber extending to said left outlet port, said right body assembly has a right rotor bore receiving said right rotor to form a first right rotor chamber, a second right rotor chamber and a third right rotor chamber extending to said right outlet port, said left body assembly has a left front extension having a left stator bore, a left outlet port, a left inlet defined by said first left rotor chamber and a left main port, and a left first of the at least one fixed wheel having said left electrical stator disposed in said left stator bore, a left second of the at least one fixed wheel having blades with a second segment ring, a left third of the at least one fixed wheel having blades with a third segment ring, a left fourth of the at least one fixed wheel having a left top pressure storage and a left low pressure storage, a left fifth of the at least one fixed wheel having at least one set of blades disposed in said third left rotor chamber, said first left rotor chamber is defined by a left top pressure chamber extending to said left top pressure storage and a left low pressure chamber extending to said left low pressure storage, said left body assembly also has a left top burner extending to said left top pressure storage and a left low burner extending to said left low pressure storage in said second left rotor chamber, said left rotor has a left first of the at least one internal rotary wheel having blades with an inside diameter dividing said left main port into a high power zone and a low power zone, at least one left set of holes communicating between said left main port and said left low pressure chamber, said left rotor also has a left first of the at least one external rotary wheel having blades, a first edge ring having a set of fan blades and said left electrical rotor engaged with said left electrical stator in said left stator bore, and a first segment ring, a left second of the at least one external rotary wheel having blades, a second edge ring and a second segment ring, a left third of the at least one external rotary wheel having blades, a third edge ring and a third segment ring, a left fourth of the at least one external rotary wheel having at least one set of blades and a left fifth of the at least one external rotary wheel having at least one set of blades sandwiching said left fourth of the at least one fixed wheel having the at least one of set of blades in said third left rotor chamber, said right body assembly has a right front extension having a right stator bore, a right outlet port, and a right inlet defined by said first right rotor chamber and a right main port, a right first of the at least one fixed wheel having said right electrical stator disposed in said right stator bore, a right second of the at least one fixed wheel having a second segment ring a right third of the at least one fixed wheel having blades, a third segment ring, a right fourth of the at least one fixed wheel having a right top pressure storage and a right low pressure storage a right fifth of the at least one fixed wheel having at least one set of blades disposed in said third right rotor chamber, said first right rotor chamber is defined by a right top pressure chamber extending to said right top pressure storage and a right low pressure chamber extending to said right low pressure storage, said right body assembly has a right top burner extending to said right top pressure storage and a right low burner extending to said right low pressure storage in said second right rotor chamber, said right rotor has a right first of the at least one internal rotary wheel having blades with an inside diameter dividing said left main port into a high power zone and a low power zone, at least one right set of holes communicating between said right main port and said right low pressure chamber, said right rotor also has a right first of the at least one external rotary wheel having blades, a first edge ring having a set of fan blades and said right electrical rotor engaged with said right electrical stator in said right stator bore, and a first segment ring, a right second of the at least one external rotary wheel having blades, a second edge ring and a second segment ring, a right third of the at least one external rotary wheel having blades, a third edge ring and a third segment ring, a right fourth of the at least one external rotary wheel having at least one set of blades and a right fifth of the at least one external rotary wheel having at least one set of blades sandwiching said tight fourth of the at least one fixed wheel having the at least one of set of blades in said third right rotor chamber.

19. The turbomachine system of claim 1, wherein said body assembly has a left electrical device having a left stator and a left electrical rotor and a right electrical device having a right stator and a right electrical rotor, and at least two heat exchangers said union has one of plurality structures including having an internal wall having a left set of blades and a right set of blades and having no an internal wall, said left body assembly has a left rotor bore receiving said left rotor to form a first left rotor chamber and a second left rotor chamber extending to said left outlet port, said right body assembly has a right rotor bore receiving said right rotor to form a first right rotor chamber, a second right rotor chamber extending to said right outlet port, said left body assembly has a left front extension having a left stator bore and a left outlet port, a left inlet defined by said first left rotor chamber and a left main port and, a left first of the at least one fixed wheel having said left electrical stator disposed in said left stator bore, a left second of the at least one fixed wheel having blades, a second segment ring, a left third of the at least one fixed wheel having blades, a third segment ring, a left fourth of the at least one fixed wheel having a left top pressure storage and a left low pressure storage respectively extending to said left second rotor chamber said first left rotor chamber is defined by a left top pressure chamber extending to said left top pressure storage and a left low pressure chamber extending to said left low pressure storage, said left rotor has a left first of the at least one internal rotary wheel having blades with an inside diameter dividing said left main port into a high power zone and a low power zone, at least one left set of holes communicating between said left main port and said left low pressure chamfer, said left rotor also has a left first of the at least one external rotary wheel having blades, a first edge ring having a set of fan blades and said left electrical rotor engaged with said left electrical stator in said left stator bore, and a first segment ring, a left second of the at least one external rotary wheel having blades, a second edge ring and a second segment ring, a left third of the at least one external rotary wheel having blades, a third edge ring and a third segment ring, a left fourth of the at least one external rotary wheel having at least one set of blades engaged with said right rotor, said right body assembly has a right front extension having a right stator bore and a right outlet port, a right inlet defined by said first right rotor chamber and a right main port, a right first of the at least one fixed wheel having said right electrical stator disposed in said right stator bore, a right second of the at least one fixed wheel having blades, a second segment ring, a right third of the at least one fixed wheel having blades, a third segment ring, a right fourth of the at least one fixed wheel having a right top pressure storage and a right low pressure storage respectively extending to said right second rotor chamber said first right rotor chamber is defined by a right top pressure chamber extending to said right top pressure storage and a right low pressure chamber extending to said right low pressure storage, said right rotor has a right first of the at least one internal rotary wheel having blades with an inside diameter dividing said left main port into a high power zone and a low power zone, at least one right set of holes communicating between said right main port and said right low pressure chamber, said right rotor also has a right first of the at least one external rotary wheel having blades, a first edge ring having a set of fan blades and said right electrical rotor engaged with said right electrical stator in said right stator bore, and a first segment ring, a right second of the at least one external rotary wheel having blades, a second edge ring and a second segment ring, a right third of the at least one external rotary wheel having blades, a third edge ring and a third segment ring, a right fourth of the at least one external rotary wheel having at least one set of blades engaged with said left rotor in said right second rotor chamber.

20. The turbomachine system of claim 1, said internal gas powers have at least one burner having a front plate having at least one front torus tube extending at least one prep-conditioning torus tube with multiple holes connected to the at least one front torus tube and multiple combustion tubes with at least one layer defined by a large diameter end connected to a post conditioning container and a smaller diameter end connected to the at least one prep-conditioning torus tube said post -conditioning container has multiple injecting holes each of said multiple combustion tubes has a fuel injector and an igniter, said internal gas powers have one of plurality of arrangement of the at least one burner including (1) in-series ways (2) parallel ways (3) a combination of in-series ways and parallel ways.
